(19) United States
(12) Patent Application Publication
(10) Pub. No.: US 2026/0257862 A1
(43) Pub. Date: Sep. 3, 2026

(54) Automated Warehouse

(71) Applicant: Daifuku Co., Ltd., Osaka-shi (JP)

(72) Inventors: Masashige Iwata, Hinocho (JP); Hiroaki Uemoto, Hinocho (JP); Takanori Nakamura, Hinocho (JP)

(21) Appl. No.: 19/551,938

(22) Filed: Feb. 27, 2026

(30) Foreign Application Priority Data
Feb. 28, 2025 (JP) 2025-031315

(51) Int. Cl. B65G 1/137; B65G 1/04; B65G 1/06

(52) U.S. Cl. CPC B65G 1/1373; B65G 1/0492; B65G 1/065; B65G 2203/0233; B65G 2203/044

(57) ABSTRACT

At least one of a feeder or a first transport vehicle in an automated warehouse places an article onto a mount of the first transport vehicle in a specific positional relationship. For a case in which a storage row to store the article is in a first storage area, the specific positional relationship is a relationship in which an end of the article on a first side in an X-direction is at a position in the X-direction which position coincides with a first end of the mount. For a case in which a storage row to store the article is in a second storage area, the specific positional relationship is a relationship in which an end of the article on a second side in the X-direction is at a position in the X-direction which position coincides with a second end of the mount.

### CROSS-REFERENCE TO RELATED APPLICATION

This application claims priority to Japanese Patent Application No. 2025-031315 filed February 28, 2025, the disclosure of which is hereby incorporated by reference in its entirety.

### BACKGROUND OF THE INVENTION

### Field of the Invention

The present invention relates to an automated warehouse.

### Description of Related Art

An example of automated warehouses is described in Japanese Unexamined Patent Application Publication No. 2019-1655 (JP 2019-1655). In the background described hereafter, reference signs in parentheses are the reference signs in JP 2019-1655. The automated warehouse described in JP 2019-1655 includes a storage rack (20), a holding rack (30), a transport cart (14), and an intermediate cart (16). The transport cart (14) transfers loads (12) into and out of the storage rack (20) and the holding rack (30). The intermediate cart (16) includes a loading platform (16c) for the transport cart (14) and transports the transport cart (14) in the row direction between the storage rack (20) and the holding rack (30). The loads (12) delivered into the automated warehouse are transported from outside into the holding rack (30) and then transported by the transport cart (14) and the intermediate cart (16) into the storage rack (20) for storage.

The storage rack (20) includes multiple storage columns (22) that can store loads (12) arranged in the column direction. The multiple storage columns (22) are connected in the row direction to form a storage array (23). The storage columns (22) include rails (41) installed in the column direction on which the transport cart (14) travels. The loads (12) are stored on the rails (41). The transport cart (14) includes a mount (14c) onto which a load (12) is placeable and a lift mechanism (14d) that raises and lowers the mount (14c). As shown in FIG. 16 in JP 2019-1655, when a load (12) is stored into a storage column (22), the mount (14c) loaded with the load (12) is lowered to place the load (12) onto the rails (41). JP 2019-1655 describes, in paragraphs 0122 and 0123 and FIG. 19, storing a load (12) that is placed onto the mount (14c) with the edge of the load (12) substantially aligned with the edge of the mount (14c) when the load (12) is stored.

In the automated warehouse described in JP 2019-1655, in which the two directions crossing each other as viewed in the vertical direction are defined as an X-direction and a Y-direction (in JP 2019-16551, the column direction and the row direction), storage areas (in JP 2019-1655, the storage arrays) include multiple storage rows provided in the Y-direction for storing multiple articles (in JP 2019-16551, loads) arranged in the X-direction. The storage areas are disposed on a first side in the X-direction relative to a Y-direction path (in JP 2019-1655, the travel path for the intermediate cart) extending in the Y-direction. Unlike such an arrangement, the storage areas may be disposed on both sides in the X-direction relative to the Y-direction path. In this case, the article storage efficiency is to be improved in the storage areas on both sides in the X-direction. However, JP 2019-1655 describes no arrangement in which storage areas are disposed on both sides in the X-direction relative to the Y-direction path.

### SUMMARY OF THE INVENTION

When storage areas are disposed on both sides in the X-direction relative to the Y-direction path, techniques are awaited for easily improving article storage efficiency in the storage areas on both sides in the X-direction.

An automated warehouse according to one aspect of the present disclosure includes a Y-direction path extending in a Y-direction, a first storage area disposed on a first side in an X-direction relative to the Y-direction path, the X-direction intersecting with the Y-direction as viewed in a vertical direction, and including a plurality of storage rows arranged in the Y-direction for storing articles arranged in the X-direction, a second storage area disposed on a second side in the X-direction relative to the Y-direction path and including a plurality of storage rows arranged in the Y-direction for storing articles arranged in the X-direction, a first transport vehicle that travels along each of the plurality of storage rows on a lower side under the articles stored in the plurality of storage rows to transport the articles, a second transport vehicle that carries the first transport vehicle and travels along the Y-direction path, and a feeder that feeds an article to the first transport vehicle. The first transport vehicle includes a mount on which the article is placeable, and a lift that raises and lowers the mount. For the first transport vehicle to transport an article to be stored in a storage row among the plurality of storage rows, at least one of the feeder or the first transport vehicle performs specific loading for placing the article onto the mount of the first transport vehicle in a specific positional relationship. For a case in which the storage row to store the article is included in the first storage area, the specific positional relationship is a first positional relationship in which an end of the article on the first side in the X-direction is at a position in the X-direction which position coincides with a first end of the mount which first end is on the first side in the X-direction or which position is farther on the first side in the X-direction than the first end of the mount. For a case in which the storage row to store the article is included in the second storage area, the specific positional relationship is a second positional relationship in which an end of the article on the second side in the X-direction is at a position in the X-direction which position coincides with a second end of the mount which second end is on the second side in the X-direction or which position is farther on the second side in the X-direction than the second end of the mount.

When the storage row to store the article is included in the first storage area disposed on the first side in the X-direction relative to the Y-direction path, this structure can perform the specific loading to place the article on the mount of the first transport vehicle in the first positional relationship, or more specifically, prevent the mount of the first transport vehicle from protruding from the article toward the first side in the X-direction. When the storage row to store the article is included in the second storage area disposed on the second side in the X-direction relative to the Y-direction path, this structure can perform the specific loading to place the article on the mount of the first transport vehicle in the second positional relationship, or more specifically, prevent the mount of the first transport vehicle from protruding from the article toward the second side in the X-direction. This allows a storage target article to be stored close to the article previously stored in the storage row without the mount of the first transport vehicle colliding with the stored article, irrespective of whether the storage row to store the article is included in the first storage area or the second storage area.

In this manner, this structure can change the state achieved by the specific loading based on whether the storage row to store the article is included in the first storage area or the second storage area, allowing the storage target article to be stored close to the stored article irrespective of the storage area in which the storage row to store the article is included. When storage areas are provided on both sides in X-direction of the Y-direction path, this easily improves article storage efficiency in both the storage areas in the X-direction.

An automated warehouse according to another aspect of the present disclosure includes a Y-direction path extending in a Y-direction, a first storage area disposed on the first side in an X-direction relative to the Y-direction path, the X-direction intersecting with the Y-direction as viewed in a vertical direction, and including a plurality of storage rows arranged in the Y-direction for storing articles arranged in the X-direction, a second storage area disposed on the second side in the X-direction relative to the Y-direction path and including a plurality of storage rows arranged in the Y-direction for storing articles arranged in the X-direction, a transport vehicle that travels along the Y-direction path and along each of the plurality of storage rows on a lower side under the articles stored in the plurality of storage rows to transport the articles, and a feeder that feeds an article to the transport vehicle. The transport vehicle includes a mount on which the article is placeable, and a lift that raises and lowers the mount. For the transport vehicle to transport an article to be stored in a storage row among the plurality of storage rows, at least one of the feeder or the transport vehicle performs specific loading for placing the article onto the mount of the transport vehicle in a specific positional relationship. For a case in which the storage row to store the article is included in the first storage area, the specific positional relationship is a first positional relationship in which an end of the article on the first side in the X-direction is at a position in the X-direction which position coincides with a first end of the mount which first end is on the first side in the X-direction or which position is farther on the first side in the X-direction than the first end of the mount. For a case in which the storage row to store the article is included in the second storage area, the specific positional relationship is a second positional relationship in which an end of the article on the second side in the X-direction is at a position in the X-direction which position coincides with a second end of the mount which second end is on the second side in the X-direction or which position is farther on the second side in the X-direction than the second end of the mount.

When the storage row to store the article is included in the first storage area disposed on the first side in the X-direction relative to the Y-direction path, this structure can perform the specific loading to place the article on the mount of the transport vehicle in the first positional relationship, or more specifically, prevent the mount of the transport vehicle from protruding from the article toward the first side in the X-direction. When the storage row to store the article is included in the second storage area disposed on the second side in the X-direction relative to the Y-direction path, this structure can perform the specific loading to place the article on the mount of the transport vehicle in the second positional relationship, or more specifically, prevent the mount of the transport vehicle from protruding from the article toward the second side in the X-direction. This allows a storage target article to be stored close to the article previously stored in the storage row without the mount of the transport vehicle colliding with the stored article, irrespective of whether the storage row to store the article is included in the first storage area or the second storage area.

In this manner, this structure can change the state achieved by the specific loading based on whether the storage row to store the article is included in the first storage area or the second storage area, allowing the storage target article to be stored close to the stored article irrespective of the storage area in which the storage row to store the article is included. When storage areas are provided on both sides in X-direction of the Y-direction path, this easily improves article storage efficiency in both the storage areas in the X-direction.

Further features and advantages of the automated warehouse will become apparent from the following description of the embodiments described with reference to the drawings.

### BRIEF DESCRIPTION OF THE DRAWINGS

FIG. 1 is a plan view of an automated warehouse.

FIG. 2 is a perspective view of a part of the automated warehouse.

FIG. 3 is a perspective view of another part of the automated warehouse.

FIG. 4 is a diagram illustrating specific loading performed when the storage row to store an article is included in a first storage area.

FIG. 5 is a diagram illustrating the specific loading performed when the storage row to store the article is included in the first storage area.

FIG. 6 is a diagram illustrating specific loading performed when the storage row to store an article is included in a second storage area.

FIG. 7 is a diagram illustrating the specific loading performed when the storage row to store the article is included in the second storage area.

FIGS. 8(a)-(e) are diagrams illustrating storage of articles into a storage row included in the first storage area.

FIGS. 9(a)-(e) are diagrams illustrating storage of articles into a storage row included in the second storage area.

FIGS. 10(a)-(d) are diagrams illustrating movement from a storage row included in the first storage area to another storage row included in the first storage area.

FIGS. 11(a)-(d) are diagrams illustrating movement from a storage row included in the first storage area to a storage row included in the second storage area.

FIGS. 12(a)-(c) are diagrams illustrating specific loading performed in movement from a storage row included in the first storage area to a storage row included in the second storage area.

FIG. 13 is a control block diagram.

FIG. 14 is a control flowchart.

FIG. 15 is a plan view of an automated warehouse according to another embodiment.

FIG. 16 is a diagram illustrating specific loading according to another embodiment performed when the storage row to store an article is included in the first storage area.

FIG. 17 is a diagram illustrating specific loading according to another embodiment performed when the storage row to store an article is included in the second storage area.

### DESCRIPTION OF THE INVENTION

An automated warehouse according to one or more embodiments will now be described with reference to the drawings. Each drawing shows components in a simplified manner as appropriate. The actual shapes and proportions may or may not be drawn to scale.

Two directions crossing each other as viewed in a vertical direction Z (in a plan view) are herein defined as an X-direction and a Y-direction. The vertical direction Z refers to the direction of gravity. The X-direction and the Y-direction are horizontal. The X-direction has a first side X1 and a second side X2 in the X-direction. The Y-direction has a first side Y1 and a second side Y2 in the Y-direction. As viewed in the vertical direction Z, the intersection angle between the X-direction and the Y-direction may be less than 90 degrees (e.g., within the range of 60 to 80 degrees). In the present embodiment, the intersection angle is 90 degrees. The X-direction and the Y-direction may be curved or bent. However, in the present embodiment, the X-direction and the Y-direction are straight.

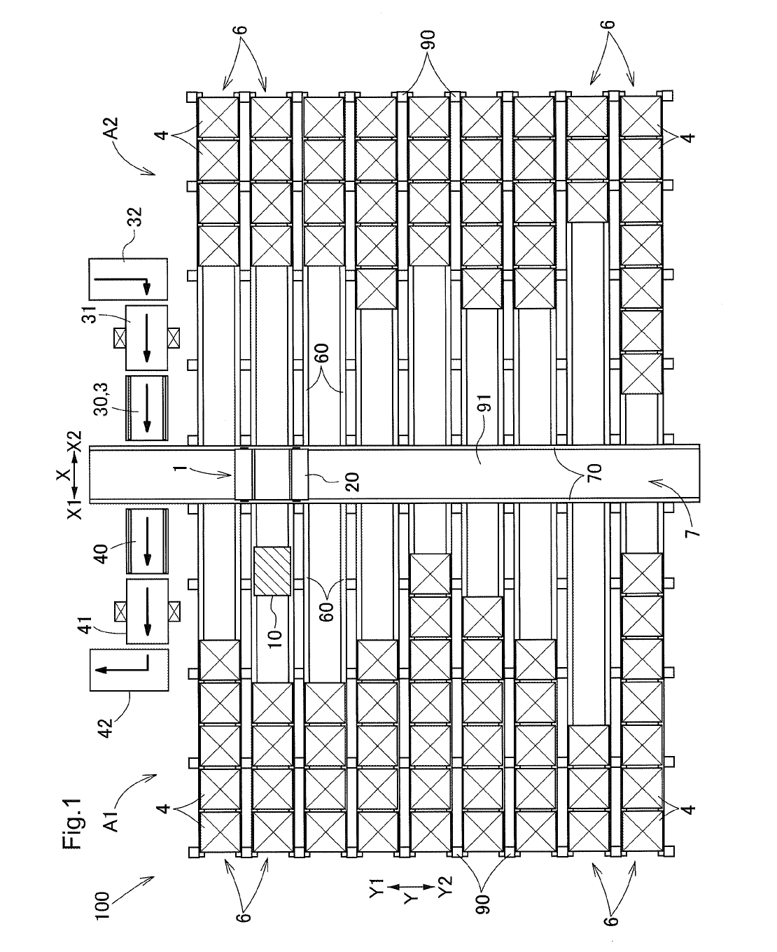

An automated warehouse 100 is a warehouse that automatically receives and ships articles 4. In the present embodiment, the types of articles 4 include, without limitation, a pallet on which a load is placeable. Each figure represents an article 4 without distinguishing between the load and the pallet. In the present embodiment, as shown in FIG. 1, articles 4 received into the automated warehouse 100 are transferred into the automated warehouse 100 through inbound equipment 32, whereas articles 4 shipped from the automated warehouse 100 are transferred from the automated warehouse 100 through outbound equipment 42. Examples of the inbound equipment 32 and the outbound equipment 42 include conveyors, such as a belt conveyor and a roller conveyor, and transport vehicles, such as an automated transport vehicle.

In the present embodiment, the articles 4 received into the automated warehouse 100 are transferred from the inbound equipment 32 to an inbound conveyor 30 directly or through other equipment. The articles 4 shipped from the automated warehouse 100 are transferred from an outbound conveyor 40 to the outbound equipment 42 directly or through other equipment. In the present embodiment, as shown in FIG. 1, the inbound conveyor 30 and the outbound conveyor 40 are installed on the first side Y1 in the Y-direction relative to storage areas (A1, A2) described later. However, the inbound conveyor 30 and the outbound conveyor 40 may be installed on the second side Y2 in the Y-direction relative to the storage areas (A1, A2) or both sides in the Y-direction relative to the storage areas (A1, A2). The inbound conveyor 30 and the outbound conveyor 40 may be separately installed on opposite sides in the Y-direction relative to the storage areas (A1, A2). Instead of installing the outbound conveyor 40 in addition to the inbound conveyor 30, the inbound conveyor 30 may be used as an outbound conveyor.

In the present embodiment, the automated warehouse 100 can store the articles 4 in each of multiple layers arranged in the vertical direction Z. FIG. 1 shows one of the multiple layers. The inbound conveyor 30 is installed on each of the multiple layers. When received into the automated warehouse 100, an article 4 is transferred from the inbound equipment 32 to the inbound conveyor 30 installed on the layer for storing the article 4 through an inbound lifter 31 including a lifting table for raising and lowering the article 4. The outbound conveyor 40 is also installed on each of the multiple layers. When shipped from the automated warehouse 100, an article 4 is transferred from the outbound conveyor 40 installed on the layer on which the article 4 is stored to the outbound equipment 42 through an outbound lifter 41 including a lifting table for raising and lowering the article 4. The lifting table of the inbound lifter 31 and the lifting table of the outbound lifter 41 include, for example, a conveyor.

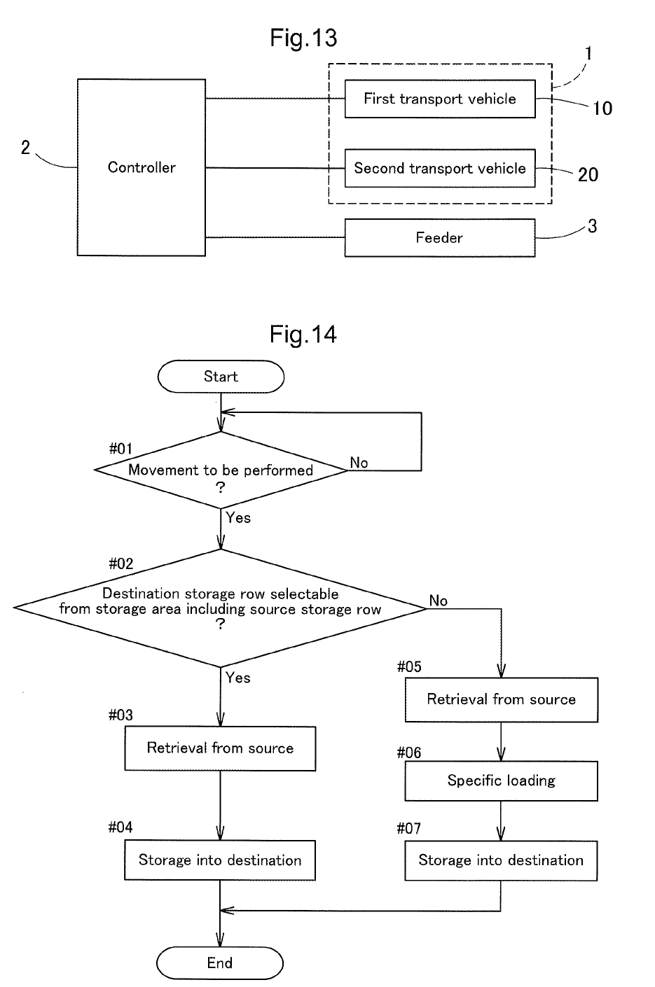

As shown in FIG. 1, the automated warehouse 100 includes a Y-direction path 7, a first storage area A1, a second storage area A2, a transport vehicle 1, and a feeder 3. In the present embodiment, the transport vehicle 1 includes a first transport vehicle 10 and a second transport vehicle 20. The automated warehouse 100 further includes a controller 2 (refer to FIG. 13).

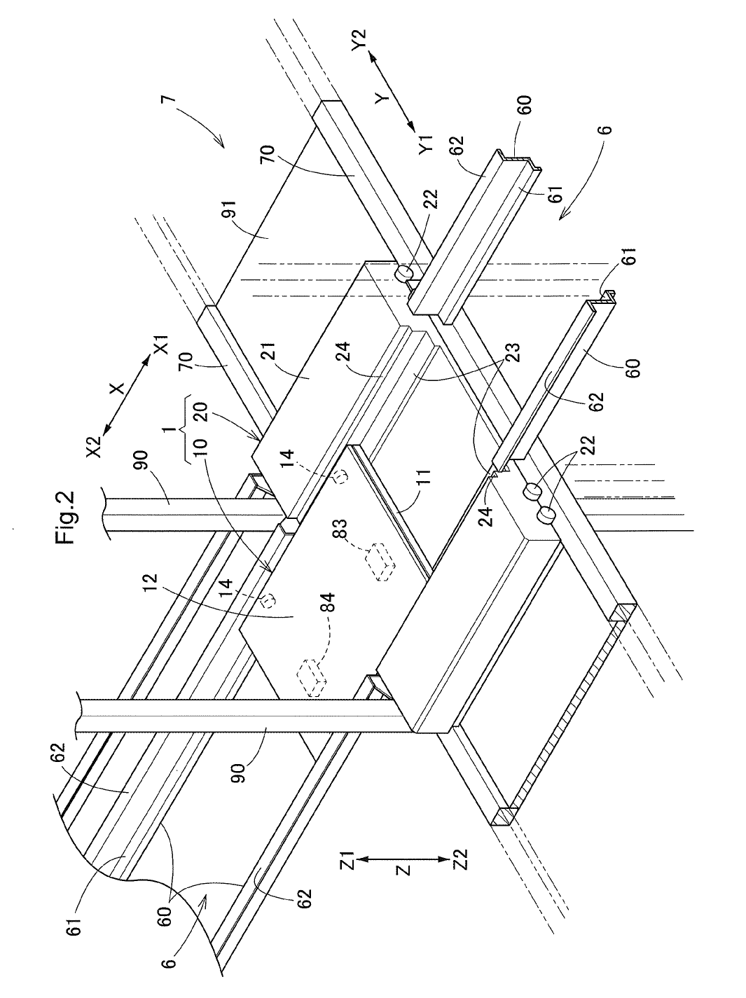

The Y-direction path 7 extends in the Y-direction. In the present embodiment, the Y-direction path 7 is installed on each of the multiple layers. In the present embodiment, as shown in FIGS. 1 and 2, the Y-direction path 7 is defined by Y-direction rails 70 extending in the Y-direction. The Y-direction rails 70 are supported by posts 90 extending in the vertical direction Z. In the embodiment, the Y-direction path 7 is defined by the Y-direction rails 70 as a pair spaced in the X-direction at the same position in the vertical direction Z. In the illustrated examples, an aisle forming member 91 for an aisle (walkway) for operators is disposed between the pair of Y-direction rails 70.

The first storage area A1 is disposed on the first side X1 in the X-direction relative to the Y-direction path 7. The second storage area A2 is disposed on the second side X2 in the X-direction relative to the Y-direction path 7. Each of the first storage area A1 and the second storage area A2 includes multiple storage rows 6 (in the example shown in FIG. 1, nine rows) arranged in the Y-direction for storing articles 4 arranged in the X-direction. In the present embodiment, the first storage area A1 and the second storage area A2 are disposed in each of the multiple layers.

In the present embodiment, each storage row 6 is defined by X-direction rails 60 extending in the X-direction. The X-direction rails 60 are supported by the posts 90. In the embodiment, the storage row 6 is defined by the X-direction rails 60 as a pair spaced in the Y-direction at the same position in the vertical direction Z. As shown in FIG. 1, articles 4 are stored in the storage row 6 with their both ends in the Y-direction supported by the pair of X-direction rails 60. More specifically, the articles 4 stored in the storage row 6 are placed on a receiving surface 62 (refer to FIG. 2) defined in each of the pair of X-direction rails 60.

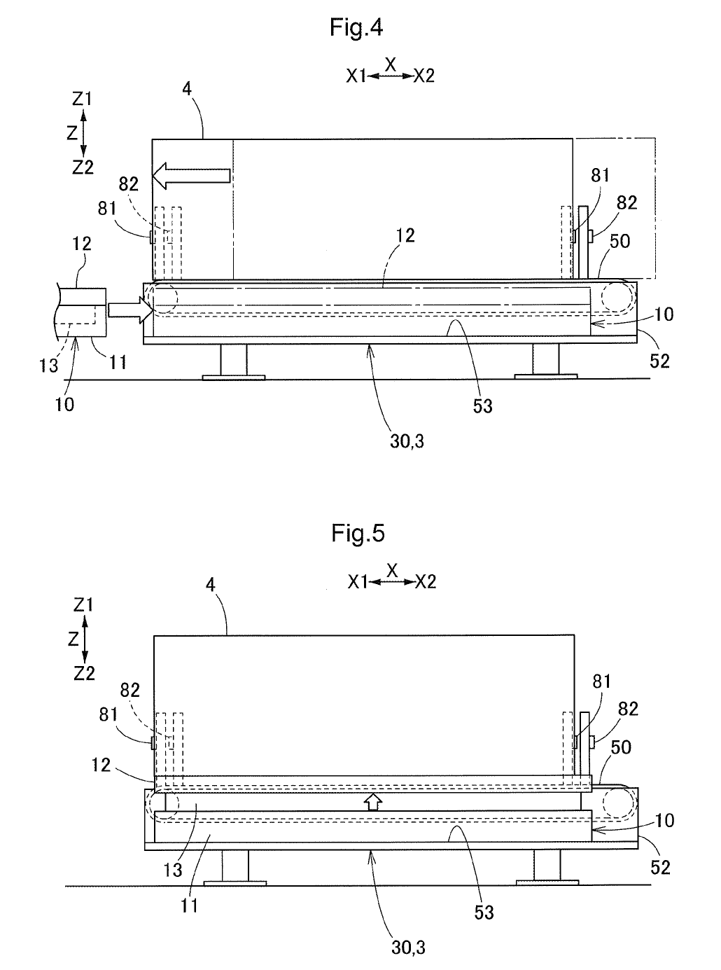

As shown in FIG. 2, the first transport vehicle 10 includes a first main body 11 including first travel wheels 14. Although FIG. 2 shows the first travel wheels 14 installed on the second side Y2 in the Y-direction, the first travel wheels 14 are installed on both ends of the first main body 11 in the Y-direction. The first travel wheels 14 are not shown in FIG. 4 and other figures. The first transport vehicle 10 travels by a driver such as an electric motor rotationally driving some or all of the first travel wheels 14. Although details are not described, the position of the first transport vehicle 10 in the X-direction is controlled based on detection information from a detector (e.g., an encoder that detects rotation of the first travel wheels 14 or a distance sensor that detects the distance to a target).

As shown in FIGS. 2 and 5, the transport vehicle 1 (in the present embodiment, the first transport vehicle 10) includes a mount 12 on which an article 4 is placeable and a lift 13 (not shown in FIG. 2) that raises and lowers the mount 12. The lift 13 raises and lowers the mount 12 relative to the first main body 11. The lift 13 raises and lowers the mount 12 by the driving force of a driver such as an electric motor. The lift 13 thus includes a power transmitter that transmits the driving force of the driver to the mount 12 (e.g., a power transmitter that converts the rotational driving force of the driver to a driving force in the vertical direction Z and transmits the driving force to the mount 12). In the present embodiment, the mount 12 includes no conveyor for conveying the article 4 in the X-direction.

The mount 12 has a dimension in the X-direction larger than the dimension of at least one of the articles 4 in the X-direction. More specifically, when the automated warehouse 100 handles articles 4 of the same dimensions, the dimension of the mount 12 in the X-direction is larger than the dimension of all the articles 4 in the X-direction. When the automated warehouse 100 handles articles 4 of dimensions different from each other, the dimension of the mount 12 in the X-direction is larger than the dimension of at least one of or all of the articles 4 in the X-direction. In contrast, the mount 12 has a dimension in the Y-direction smaller than the dimension of all of the articles 4 in the Y-direction.

In the example shown in FIG. 2, the first transport vehicle 10 includes a third detector 83 and a fourth detector 84. For example, the third detector 83 and the fourth detector 84 are installed to detect the pallet included in an article 4. For example, the third detector 83 and the fourth detector 84 are sensors that detect an article 4 and determine the distance to the article 4 based on interruption or reflection of light. The third detector 83 is used, for example, to detect any article 4 on the first side X1 in the X-direction relative to the first transport vehicle 10, the distance to any article 4 on the first side X1 in the X-direction relative to the first transport vehicle 10, or the position of the end of any article 4 on the first side X1 in the X-direction disposed on an upper side Z1 relative to the first transport vehicle 10. The fourth detector 84 is used, for example, to detect any article 4 on the second side X2 in the X-direction relative to the first transport vehicle 10, the distance to any article 4 on the second side X2 in the X-direction relative to the first transport vehicle 10, or the position of the end of any article 4 on the second side X2 in the X-direction disposed on the upper side Z1 relative to the first transport vehicle 10.

The first transport vehicle 10 travels along each storage row 6 on the lower side Z2 under the articles 4 stored in the storage row 6 to transport the articles 4. In the present embodiment, the travel path in the storage row 6 for the first transport vehicle 10 is defined by the pair of X-direction rails 60. More specifically, as shown in FIG. 2, the X-direction rails 60 have running surfaces 61 on which the first travel wheels 14 roll. The first transport vehicle 10 travels in the X-direction along the pair of running surfaces 61 (specifically, along the storage row 6) defined on the pair of X-direction rails 60.

When the side facing the center in the Y-direction between the pair of X-direction rails 60 arranged along one storage row 6 is defined as inward in the Y-direction, each running surface 61 is defined on the X-direction rail 60, inward in the Y-direction from the receiving surface 62 on the same X-direction rail 60. The running surface 61 is defined on the X-direction rail 60, on the lower side Z2 relative to the receiving surface 62 on the same X-direction rail 60. The first transport vehicle 10 (specifically, the first transport vehicle 10 with the mount 12 lowered) travels on the lower side Z2 under the article 4 placed on the receiving surface 62. This allows the first transport vehicle 10 to enter the lower side Z2 under the articles 4 stored in the storage row 6.

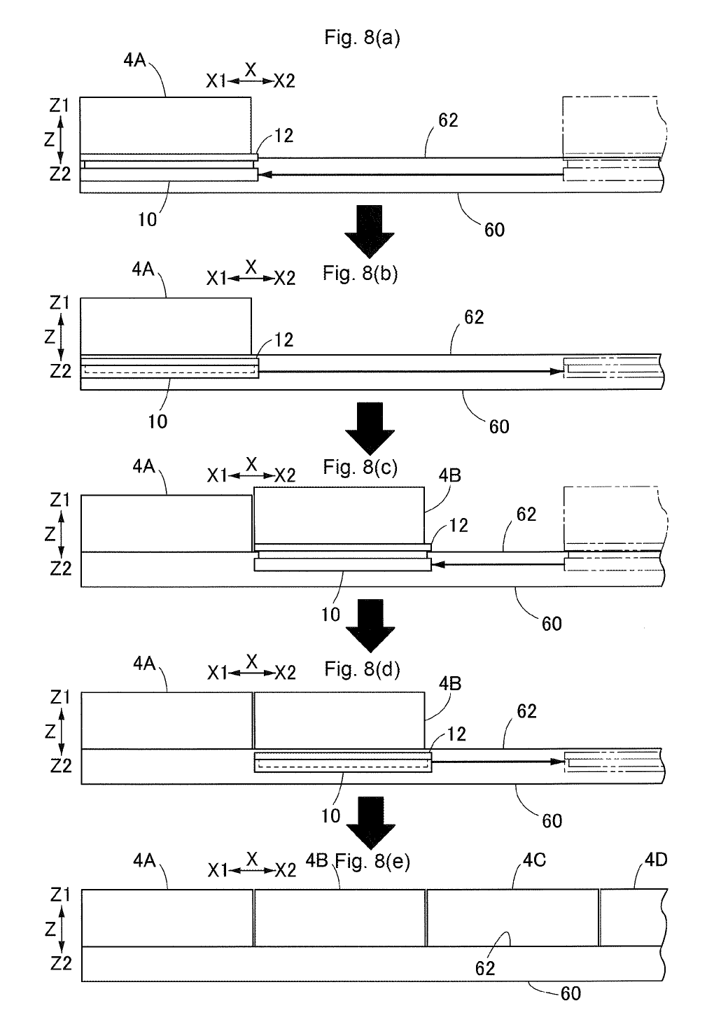

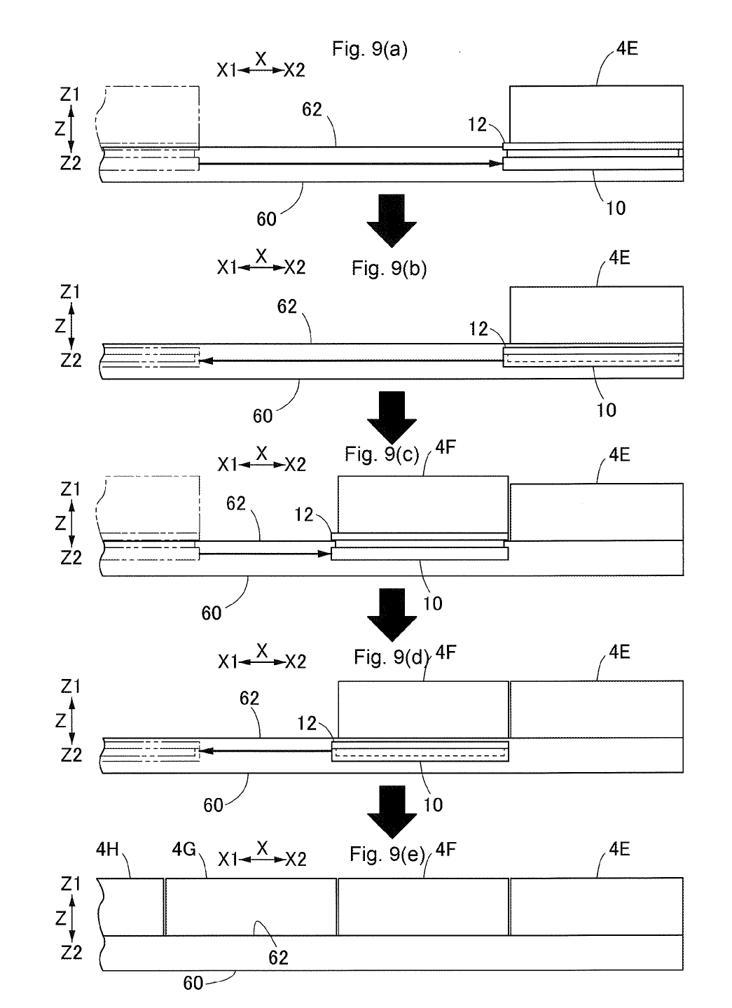

To store an article 4 in the storage row 6, the first transport vehicle 10 enters the storage row 6 with the mount 12 raised to position the bottom surface of the article 4 placed on the mount 12 on the upper side Z1 above the receiving surface 62 and travels to the position at which the article 4 is to be stored (refer to FIGS. 8(a) and 9(a)). The first transport vehicle 10 then lowers the mount 12 to place the article 4 on the mount 12 onto the receiving surface 62, before exiting the storage row 6 (refer to FIGS. 8(b) and 9(b)). The stopping position of the first transport vehicle 10 to store an article 4 in the storage row 6 is controlled based on, for example, detection results from the third detector 83 or the fourth detector 84 for the article previously stored in the storage row 6 (e.g., detection results of the distance to the stored article).

The articles 4 are stored into the storage row 6 sequentially from the end in the X-direction farther from the Y-direction path7 (the first side X1 in the X-direction for the first storage area A1 and the second side X2 in the X-direction for the second storage area A2). FIGS. 8(a)-(e) show storage of a first article 4A, a second article 4B, a third article 4C, and a fourth article 4D into the storage row 6 included in the first storage area A1. The four articles 4 are stored sequentially from the first side X1 in the X-direction, as shown in chronological order in FIGS. 8(a), 8(b), 8(c), 8(d), and 8(e). FIGS. 9(a)-(e) show storage of a fifth article 4E, a sixth article 4F, a seventh article 4G, and an eighth article 4H into the storage row 6 included in the second storage area A2. The four articles 4 are stored sequentially from the second side X2 in the X-direction, as shown in chronological order in FIGS. 9(a), 9(b), 9(c), 9(d), and 9(e).

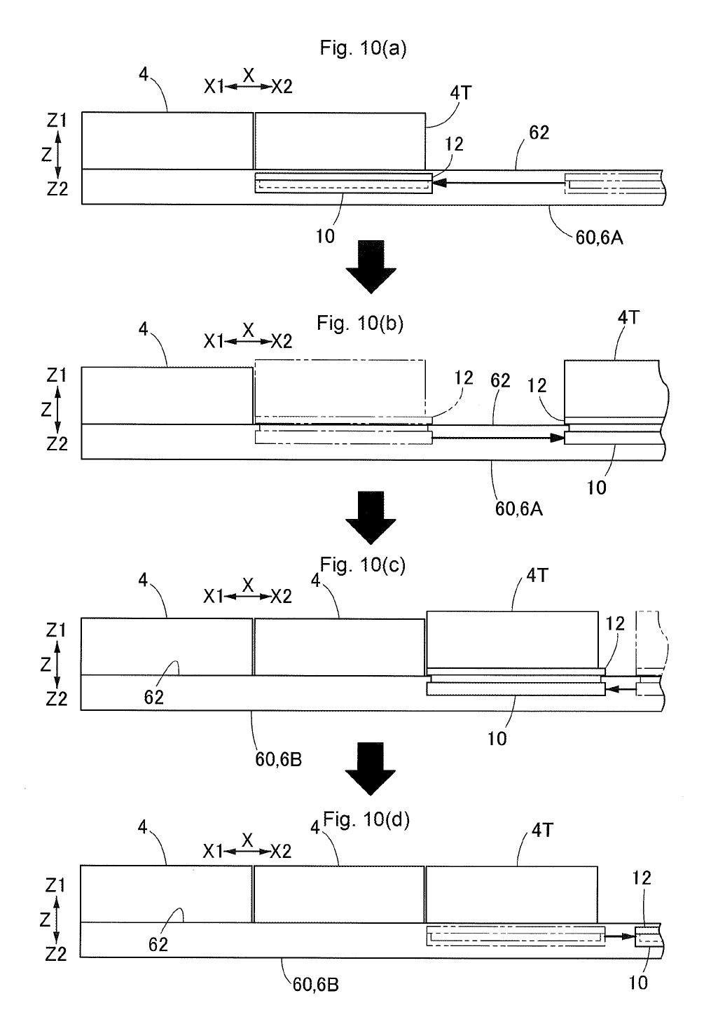

When an article 4 is retrieved from the storage row 6, the first transport vehicle 10 enters the lower side Z2 under the target article 4 with the mount 12 lowered to position the top surface of the mount 12 on the lower side Z2 under the receiving surface 62 (refer to FIG. 10(a)). In FIG. 10(a), an article 4T is the target article 4. The first transport vehicle 10 then raises the mount 12 to place the article 4 placed on the receiving surface 62 onto the mount 12, before exiting the storage row 6 (refer to FIG. 10(b)). The stopping position of the first transport vehicle 10 to retrieve an article 4 from the storage row 6 is controlled based on, for example, detection results from the third detector 83 or the fourth detector 84 for the article 4 (e.g., detection results of the end position of the article 4 in the X-direction).

The articles 4 are retrieved from the storage row 6 sequentially from the end in the X-direction closer to the Y-direction path 7 (the second side X2 in the X-direction for the first storage area A1 and the first side X1 in the X-direction for the second storage area A2). FIGS. 10(a) to 10(b) show the storage row 6 included in the first storage area A1, illustrating retrieval of the article 4 (an article 4T) at the farthest position on the second side X2 in the X-direction among the articles previously stored in the storage row 6.

The second transport vehicle 20 travels along the Y-direction path 7. As shown in FIG. 2, the second transport vehicle 20 includes a second main body 21 including second travel wheels 22. Although FIG. 2 shows the second travel wheels 22 installed on the first side X1 in the X-direction, the second travel wheels 22 are installed on both ends of the second main body 21 in the X-direction. The second transport vehicle 20 travels by a driver such as an electric motor rotationally driving some or all of the second travel wheels 22. In the present embodiment, as described above, the Y-direction path 7 is defined by the pair of Y-direction rails 70. The second transport vehicle 20 travels on the pair of Y-direction rails 70 in the Y-direction (specifically, along the Y-direction path 7). Although details are not described, the position of the second transport vehicle 20 in the Y-direction is controlled based on detection information from a detector (e.g., an encoder that detects the rotation of the second travel wheels 22 or a distance sensor that detects the distance to a target).

The second transport vehicle 20 can carry the first transport vehicle 10. In other words, in the present embodiment, the transport vehicle 1 is a mother-daughter cart including the first transport vehicle 10 as a daughter cart and the second transport vehicle 20 as a mother cart. The first transport vehicle 10 moves in the X-direction as the first transport vehicle 10 travels. The first transport vehicle 10 moves in the Y-direction as the second transport vehicle 20 carrying the first transport vehicle 10 travels. In the present embodiment, as shown in FIG. 2, the second main body 21 of the second transport vehicle 20 includes rails 23 extending in the X-direction on which the first travel wheels 14 of the first transport vehicle 10 roll. In the embodiment, the second main body 21 includes the rails 23 as a pair spaced in the Y-direction, and the first transport vehicle 10 travels on the pair of rails 23 in the X-direction. The first transport vehicle 10 is mounted on the second transport vehicle 20 with both sides in the Y-direction supported by the pair of rails 23.

The first transport vehicle 10 exiting a storage row 6 is mounted onto the second transport vehicle 20 or the first transport vehicle 10 entering a storage row 6 is removed from the second transport vehicle 20 with the second transport vehicle 20 at the position in the Y-direction corresponding to the storage row 6. In the present embodiment, at the position in the Y-direction corresponding to the storage row 6, the rails 23 installed on the second transport vehicle 20 are aligned with the extension of the X-direction rails 60 arranged in the storage row 6, as shown in FIG. 2. More specifically, at the position in the Y-direction corresponding to the storage row 6, the rail 23 on the first side Y1 in the Y-direction of the pair of rails 23 installed on the second transport vehicle 20 is aligned with the extension of the X-direction rail 60 on the first side Y1 in the Y-direction of the pair of X-direction rails 60 arranged in the storage row 6. The rail 23 on the second side Y2 in the Y-direction of the pair of rails 23 installed on the second transport vehicle 20 is aligned with the extension of the X-direction rail 60 on the second side Y2 in the Y-direction of the pair of X-direction rails 60 arranged in the storage row 6.

In the present embodiment, as shown in FIG. 2, the second main body 21 of the second transport vehicle 20 includes supports 24 that support the article 4. In the embodiment, the second main body 21 includes the supports 24 as a pair spaced in the Y-direction. When the side facing away from the center in the Y-direction between the pair of rails 23 on the second main body 21 is defined as an outward in the Y-direction, the pair of supports 24 are arranged outward in the Y-direction from the pair of rails 23 and on the upper side Z1 above the pair of rails 23. The article 4 is thus supported by the pair of supports 24 on both sides in the Y-direction on the upper side Z1 above the pair of rails 23.

The supports 24 have a height (a position in the vertical direction Z) between the highest position and the lowest position of the vertical travel range of the upper surface of the mount 12 in the first transport vehicle 10. This allows the first transport vehicle 10 mounted on the second transport vehicle 20 to place the article 4 on the mount 12 onto the supports 24 by lowering the mount 12 and place the article 4 supported by the supports 24 onto the mount 12 by raising the mount 12. For example, when the second transport vehicle 20 carrying the first transport vehicle 10 is moved, lowering the mount 12 of the first transport vehicle 10 allows the article 4 to be supported by the supports 24. In this case, when the mount 12 is raised to place the article 4 onto the mount 12 again, the mount 12 can be raised without changing the position of the first transport vehicle 10 in the X-direction to maintain the positional relationship of the article 4 to the mount 12.

The feeder 3 feeds an article 4 onto the transport vehicle 1 (in the present embodiment, the first transport vehicle 10). In the present embodiment, the inbound conveyor 30, which receives an article 4 transported for storage into the storage row 6, feeds the article 4 onto the first transport vehicle 10. More specifically, the feeder 3 includes the inbound conveyor 30. The feeder 3 feeds the article 4 onto the first transport vehicle 10 by transferring the article 4 received by the inbound conveyor 30 from the inbound conveyor 30 to the first transport vehicle 10. The first transport vehicle 10 fed with the article 4 in the inbound conveyor 30 moves to the position in the Y-direction corresponding to the storage row 6 to store the article 4 while mounted on the second transport vehicle 20, before entering the storage row 6 to store the article 4.

As shown in FIG. 1, the inbound conveyor 30 is disposed along the Y-direction path 7 in a Y-direction area to which at least one of the first storage area A1 or the second storage area A2 is unconnected. In the present embodiment, the outbound conveyor 40 for transferring the article 4 retrieved from the storage row 6 is installed at a position facing the inbound conveyor 30 in the X-direction across the Y-direction path 7. The inbound conveyor 30 is thus disposed along the Y-direction path 7 in a Y-direction area to which neither the first storage area A1 nor the second storage area A2 is connected. When the outbound conveyor 40 is not installed at a position facing the inbound conveyor 30 in the X-direction across the Y-direction path 7, for example, when the inbound conveyor 30 is also used as an outbound conveyor, the inbound conveyor 30 may be disposed along the Y-direction path 7 in a Y-direction area to which one of the first storage area A1 and the second storage area A2 is unconnected. In this case, for example, a storage row 6 included in the first storage area A1 or the second storage area A2 may be disposed at a position facing the inbound conveyor 30 in the X-direction across the Y-direction path 7.

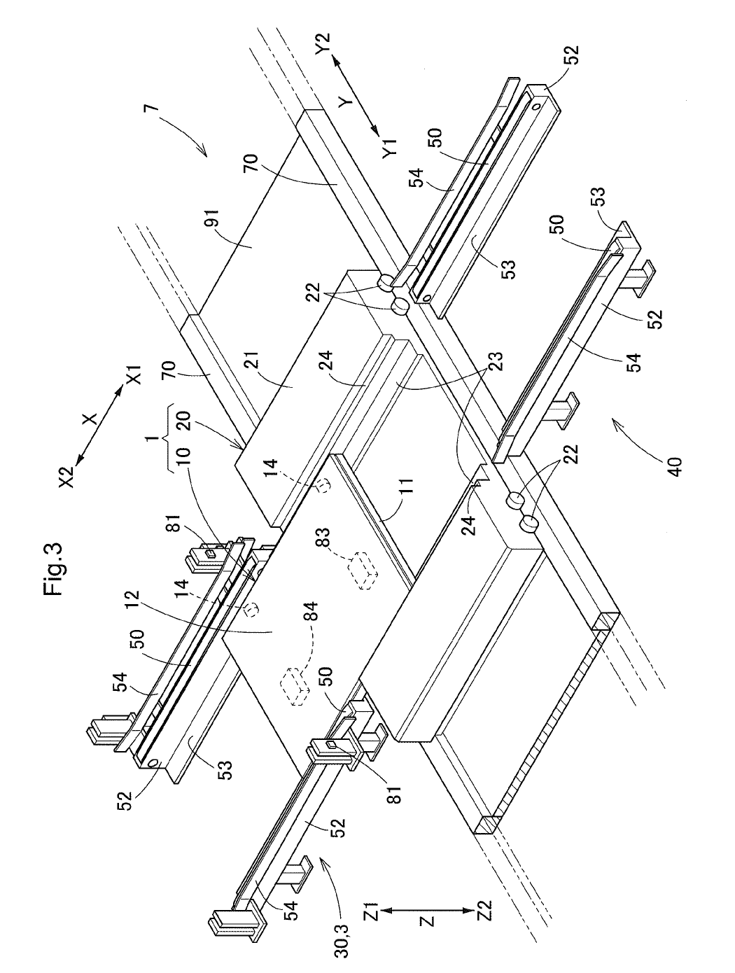

In the present embodiment, the inbound conveyor 30 conveys the article 4 in the X-direction. In this example, the inbound conveyor 30 includes conveyors arranged in two rows spaced in the Y-direction. As shown in FIG. 3, each of the two rows of conveyors includes a frame 52 and an endless transmission member 50 wrapped around multiple rollers supported by the frame 52. The transmission member 50 is, for example, a chain or a belt. The multiple rollers include drive pulleys driven by a driver such as an electric motor. The inbound conveyor 30 drives and rotates the drive pulleys in each of the two rows of conveyors to convey the article 4 in the X-direction. In this manner, the inbound conveyor 30 includes a pair of transmission members 50, or specifically, the transmission member 50 installed in a first one of the two rows of conveyors and the transmission member 50 installed in a second one of the two rows of conveyors. The side of the inbound conveyor 30 facing the center in the Y-direction between the pair of transmission members 50 is hereafter defined as inward in the Y-direction, whereas the opposite side (specifically, the side facing away from the center in the Y-direction between the pair of transmission members 50) is hereafter defined as outward in the Y-direction. In the example shown in FIG. 3, each of the two rows of conveyors includes a guide member 54 arranged outward in the Y-direction from the transmission member 50 for guiding the article 4 in the X-direction.

In the present embodiment, the inbound conveyor 30 transfers the article 4 to the first transport vehicle 10 that has entered the inbound conveyor 30. The inbound conveyor 30 thus includes rails 53 extending in the X-direction on which the first travel wheels 14 of the first transport vehicle 10 roll. The rails 53 are supported by the frames 52. In this example, the inbound conveyor 30 includes the rails 53 as a pair spaced in the Y-direction. The first transport vehicle 10 travels on the pair of rails 53 in the X-direction. A first one of the pair of rails 53 is supported by the frame 52 in the first one of the two rows of conveyors, whereas a second one of the pair of rails 53 is supported by the frame 52 in the second one of the two rows of conveyors. In FIG. 3, of the pair of rails 53 installed in the inbound conveyor 30, the rail 53 on the first side Y1 in the Y-direction is hidden.

The pair of rails 53 are disposed inward in the Y-direction from the pair of transmission members 50 and on the lower side Z2 under the upper end of the pair of transmission members 50 (the part that supports the article 4). The first transport vehicle 10 (specifically, the first transport vehicle 10 with the mount 12 lowered) travels on the lower side Z2 under the article 4 supported on the pair of transmission members 50. This allows the first transport vehicle 10 to enter the lower side Z2 under the article 4 supported on the inbound conveyor 30.

The first transport vehicle 10 entering the inbound conveyor 30 is removed from the second transport vehicle 20 or the first transport vehicle 10 exiting the inbound conveyor 30 is mounted onto the second transport vehicle 20 with the second transport vehicle 20 at the position in the Y-direction corresponding to the inbound conveyor 30. In the present embodiment, at the position in the Y-direction corresponding to the inbound conveyor 30, the rails 23 installed on the second transport vehicle 20 are aligned with the extension of the rails 53 installed on the inbound conveyor 30, as shown in FIG. 3. More specifically, at the position in the Y-direction corresponding to the inbound conveyor 30, the rail 23 on the first side Y1 in the Y-direction of the pair of rails 23 installed on the second transport vehicle 20 is aligned with the extension of the rail 53 on the first side Y1 in the Y-direction of the pair of rails 53 installed on the inbound conveyor 30. The rail 23 on the second side Y2 in the Y-direction of the pair of rails 23 installed on the second transport vehicle 20 is aligned with the extension of the rail 53 on the second side Y2 in the Y-direction of the pair of rails 53 installed on the inbound conveyor 30.

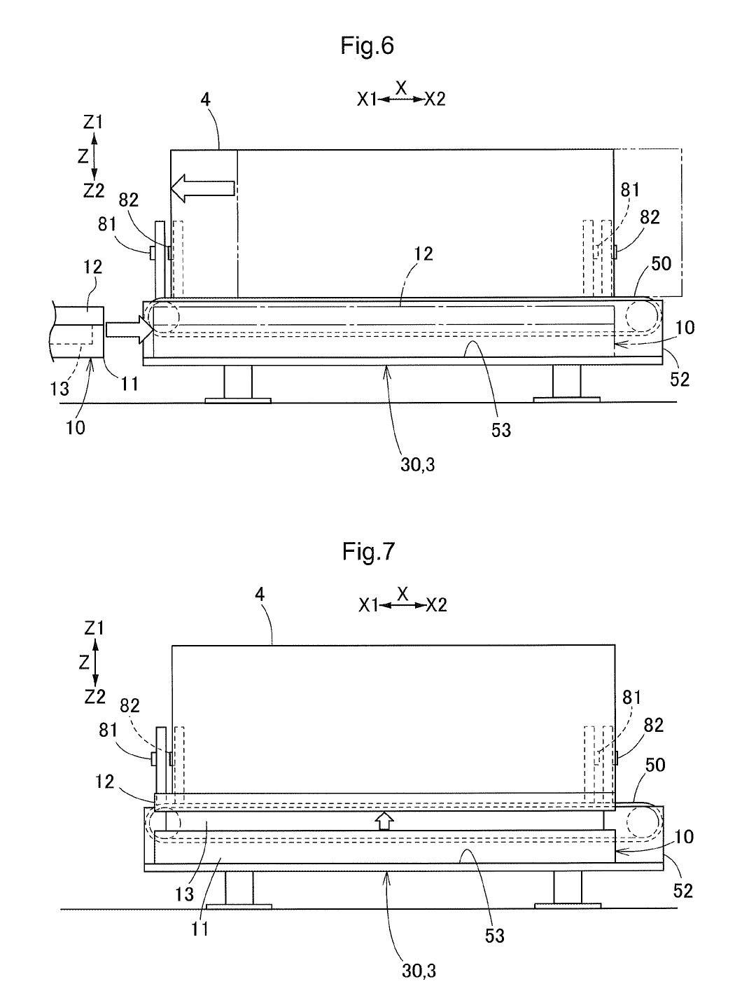

In the present embodiment, as shown in FIG. 4, the first transport vehicle 10 with the mount 12 lowered is removed from the second transport vehicle 20 to enter the lower side Z2 under an article 4 supported on the inbound conveyor 30. As shown in FIG. 5, the mount 12 of the first transport vehicle 10 is then raised to place the article 4 onto the mount 12. In this manner, the article 4 is transferred from the inbound conveyor 30 to the first transport vehicle 10. In FIGS. 4 and 5, the Y-direction path 7 and the second transport vehicle 20 are not shown. The same applies to FIGS. 6, 7, 12(a)-(c), 16, and 17 , which are referred to later. The first transport vehicle 10 that has received the article 4 exits the inbound conveyor 30 with the mount 12 raised and is mounted onto the second transport vehicle 20. The first transport vehicle 10 then moves to the position in the Y-direction corresponding to the storage row 6 to store the article 4 while mounted on the second transport vehicle 20. The first transport vehicle 10 then leaves the second transport vehicle 20, enters the storage row 6 to store the article 4, and stores the article 4 into the storage row 6.

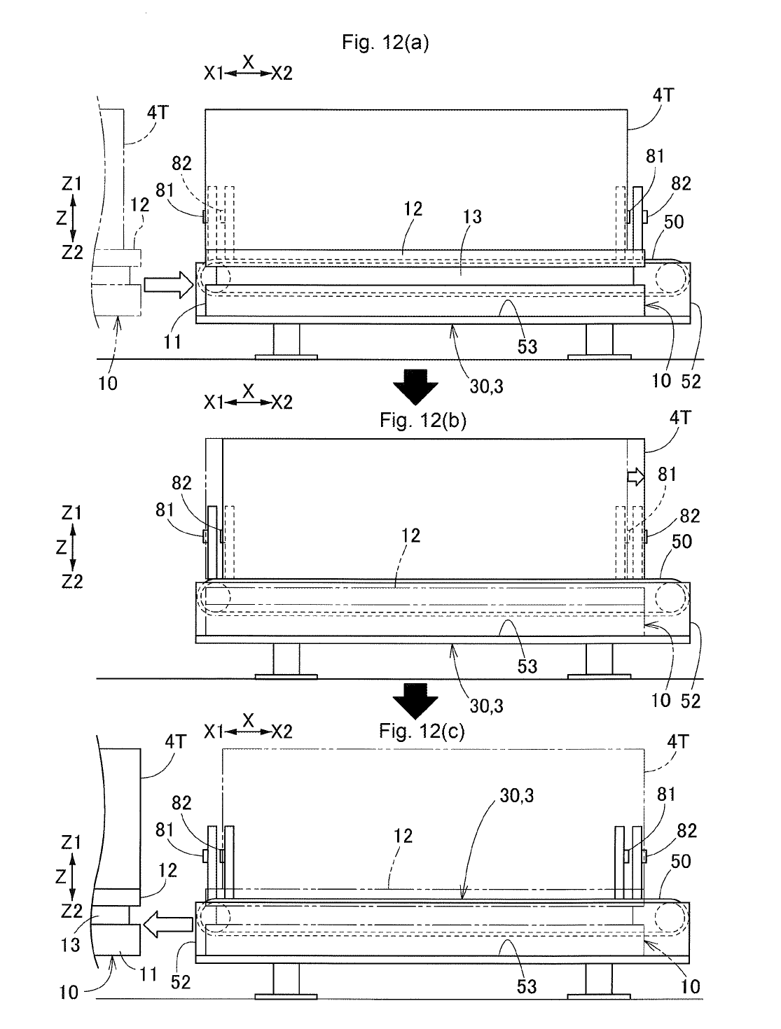

In the movement described later, the first transport vehicle 10 temporarily transfers the article 4 to the inbound conveyor 30. In this case, the first transport vehicle 10 that has retrieved the article 4 from the storage row 6 moves to the position in the Y-direction corresponding to the inbound conveyor 30 while mounted on the second transport vehicle 20. As shown in FIG. 12(a), the first transport vehicle 10 then enters the inbound conveyor 30 with the mount 12 loaded with the article 4 (in FIGS. 12(a)-(c) , the target article 4T) being raised. As shown in FIG. 12(b), the first transport vehicle 10 lowers the mount 12 to place the article 4 on the mount 12 onto the inbound conveyor 30 (specifically, the pair of transmission members 50 included in the inbound conveyor 30). The article 4 is thus transferred from the first transport vehicle 10 to the inbound conveyor 30. In the present embodiment, as shown in FIG. 3, the outbound conveyor 40 has the same design as the inbound conveyor 30 except that no detectors (81, 82) described later are installed. When the article 4 retrieved from the storage row 6 is shipped, the first transport vehicle 10 operates in the same manner as described above to place the article 4 on the mount 12 onto the outbound conveyor 40 (specifically, the pair of transmission members 50 in the outbound conveyor 40). The article 4 is thus transferred from the first transport vehicle 10 to the outbound conveyor 40.

As shown in FIG. 13, the controller 2 controls the transport vehicle 1 and the feeder 3. In the present embodiment, the transport vehicle 1 includes the first transport vehicle 10 and the second transport vehicle 20. The controller 2 thus controls the first transport vehicle 10, the second transport vehicle 20, and the feeder 3 (in the present embodiment, the inbound conveyor 30). The controller 2 may control other equipment (e.g., the outbound conveyor 40). The controller 2 includes an arithmetic processor such as a microcomputer, and a peripheral circuit such as a memory. The functions of the controller 2 are implemented by hardware such as the arithmetic processor cooperating with a program executed on the hardware. The controller 2 may be implemented by a single device or by multiple devices that can communicate with one another. In FIG. 13, the controller 2 is shown as distinct from the first transport vehicle 10, the second transport vehicle 20, and the feeder 3. However, the controller 2 may not be a physically distinct device. A device included in at least one of the first transport vehicle 10, the second transport vehicle 20, and the feeder 3 may function as at least a part of the controller 2.

The automated warehouse 100 described herein (specifically, the controller 2) has various technical features that are also applicable to a method implemented by the controller 2 to control the automated warehouse 100 (automated warehouse control method) or a program for causing a computer to function as the controller 2 (automated warehouse control program). Such an automated warehouse control method and an automated warehouse control program, as well as a storage medium storing the automated warehouse control program (e.g., a computer-readable storage medium such as an optical disc or a flash memory) are also described herein.

In the automated warehouse 100, when the article 4 to be stored into the storage row 6 is transported on the transport vehicle 1 (in the present embodiment, the first transport vehicle 10), at least one of the feeder 3 or the transport vehicle 1 (in the present embodiment, the first transport vehicle 10) performs specific loading to load the mount 12 with the article 4 in a specific positional relationship. When the storage row 6 to store the article 4 is included in the first storage area A1, the specific positional relationship is a first positional relationship described later. When the storage row 6 to store the article 4 is included in the second storage area A2, the specific positional relationship is a second positional relationship described later. More specifically, when the storage row 6 to store the article 4 is included in the first storage area A1, specific loading places the article 4 onto the mount 12 in the first positional relationship. When the storage row 6 to store the article 4 is included in the second storage area A2, specific loading places the article 4 onto the mount 12 in the second positional relationship.

In the present embodiment, as shown in FIG. 5, the first positional relationship is a positional relationship in which the X-direction end of the article 4 on the first side X1 in the X-direction coincides with the end of the mount 12 on the first side X1 in the X-direction. When the storage row 6 to store the article 4 is included in the first storage area A1, and multiple articles 4 (in FIG. 8, four articles 4, or specifically, the first article 4A, the second article 4B, the third article 4C, and the fourth article 4D) are sequentially stored from the first side X1 in the X-direction as shown in FIG. 8, the placement of the article 4 on the mount 12 in this positional relationship allows the target article 4 to be stored close to (e.g., with a small gap from) the article previously stored in the storage row 6 without the mount 12 colliding with the stored article.

The first positional relationship may be a positional relationship in which the X-direction end of the article 4 on the first side X1 in the X-direction is positioned farther on the first side X1 in the X-direction than the end of the mount 12 on the first side X1 in the X-direction. The first positional relationship may vary based on the X-direction dimension of the article 4 placed on the mount 12. For example, the first positional relationship may be defined as described below. When the article 4 placed on the mount 12 has an X-direction dimension smaller than or equal to the X-direction dimension of the mount 12, the X-direction end of the article 4 on the first side X1 in the X-direction coincides with the end of the mount 12 on the first side X1 in the X-direction. When the article 4 placed on the mount 12 has an X-direction dimension larger than the X-direction dimension of the mount 12, the X-direction end of the article 4 on the first side X1 in the X-direction is positioned farther on the first side X1 in the X-direction than the end of the mount 12 on the first side X1 in the X-direction.

In the present embodiment, as shown in FIG. 7, the second positional relationship is a positional relationship in which the X-direction end of the article 4 on the second side X2 in the X-direction coincides with the end of the mount 12 on the second side X2 in the X-direction. When the storage row 6 to store the article 4 is included in the second storage area A2, and multiple articles 4 (in FIGS. 9(a)-(e) , four articles 4, or specifically, the fifth article 4E, the sixth article 4F, the seventh article 4G, and the eighth article 4H) are sequentially stored from the second side X2 in the X-direction as shown in FIGS. 9(a)-(e) , the placement of the article 4 on the mount 12 in this positional relationship allows the target article 4 to be stored close to the article previously stored in the storage row 6 without the mount 12 colliding with the stored article.

The second positional relationship may be a positional relationship in which the X-direction end of the article 4 on the second side X2 in the X-direction is positioned farther on the second side X2 in the X-direction than the end of the mount 12 on the second side X2 in the X-direction. The second positional relationship may vary based on the X-direction dimension of the article 4 placed on the mount 12. For example, the second positional relationship may be defined as described below. When the article 4 placed on the mount 12 has an X-direction dimension smaller than or equal to the X-direction dimension of the mount 12, the X-direction end of the article 4 on the second side X2 in the X-direction coincides with the end of the mount 12 on the second side X2 in the X-direction. When the article 4 placed on the mount 12 has an X-direction dimension larger than the X-direction dimension of the mount 12, the X-direction end of the article 4 on the second side X2 in the X-direction is positioned farther on the second side X2 in the X-direction than the end of the mount 12 on the second side X2 in the X-direction.

In the present embodiment, the specific loading is performed by adjusting the positional relationship (specifically, positional relationship in the X-direction) between the mount 12 and the article 4 when the article 4 is transferred from the inbound conveyor 30 to the transport vehicle 1 (in the present embodiment, the first transport vehicle 10). In the present embodiment, irrespective of whether the storage row 6 to store the article 4 is included in the first storage area A1 or the second storage area A2, the transfer of the article 4 from the inbound conveyor 30 to the first transport vehicle 10 is performed with the transport vehicle 1 (in the present embodiment, the first transport vehicle 10) at a fixed position. In FIGS. 4 and 6, the fixed position is the position of the first transport vehicle 10 indicated by a dash-dot line. In FIGS. 5 and 7, the fixed position is the position of the first transport vehicle 10 indicated by a solid line. The adjustment of the positional relationship between the mount 12 and the article 4 during the specific loading is performed by adjusting the position of the article 4 on the inbound conveyor 30 (specifically, the position in the X-direction). In the present embodiment, the position of the article 4 on the inbound conveyor 30 is adjusted by driving of the pair of transmission members 50.

The feeder 3 adjusts the position of the article 4 on the inbound conveyor 30 with the article 4 spaced from the mount 12. After the position of the article 4 is adjusted on the inbound conveyor 30, the first transport vehicle 10 raises the mount 12 to place the article 4 onto the mount 12 in the specific positional relationship. In the present embodiment, the specific loading is performed in this manner by the feeder 3 and the first transport vehicle 10. The specific loading will be described in detail below with reference to FIGS. 4 to 7.

FIGS. 4 and 5 show an example of specific loading performed when the storage row 6 to store the article 4 is included in the first storage area A1 (specifically, specific loading for placing the article 4 onto the mount 12 in the first positional relationship). As shown in FIG. 4, the first transport vehicle 10 with the mount 12 lowered enters the inbound conveyor 30 and stops at the fixed position. The inbound conveyor 30 included in the feeder 3 conveys the article 4 received from the second side X2 in the X-direction toward the first side X1 in the X-direction (refer to a white arrow in FIG. 4) until the article 4 is positioned in the first positional relationship relative to the mount 12 (in this example, the positional relationship in which the X-direction end of the article 4 on the first side X1 in the X-direction coincides with the end of the mount 12 on the first side X1 in the X-direction). As shown in FIG. 5, the first transport vehicle 10 raises the mount 12 to place the article 4 onto the mount 12 in the first positional relationship.

FIGS. 6 and 7 show an example of specific loading performed when the storage row 6 to store the article 4 is included in the second storage area A2 (specifically, specific loading for placing the article 4 onto the mount 12 in the second positional relationship). As shown in FIG. 6, the first transport vehicle 10 with the mount 12 lowered enters the inbound conveyor 30 and stops at the fixed position. The inbound conveyor 30 included in the feeder 3 conveys the article 4 received from the second side X2 in the X-direction toward the first side X1 in the X-direction (refer to a white arrow in FIG. 6) until the article 4 is positioned in the second positional relationship relative to the mount 12 (in this example, the positional relationship in which the X-direction end of the article 4 on the second side X2 in the X-direction coincides with the end of the mount 12 on the second side X2 in the X-direction). As shown in FIG. 7, the first transport vehicle 10 raises the mount 12 to place the article 4 onto the mount 12 in the second positional relationship.

In the present embodiment, the automated warehouse 100 includes a first detector 81 and a second detector 82. The first detector 81 detects the article 4 being positioned on the inbound conveyor 30 in the first positional relationship relative to the mount 12 of the transport vehicle 1 (in the present embodiment, the first transport vehicle 10) at the fixed position. The second detector 82 detects the article 4 being positioned on the inbound conveyor 30 in the second positional relationship relative to the mount 12 of the transport vehicle 1 (in the present embodiment, the first transport vehicle 10) at the fixed position. For example, the first detector 81 and the second detector 82 are installed to detect the pallet included in an article 4.

In the present embodiment, as shown in FIGS. 3 to 7, the first detector 81 and the second detector 82 are installed on the inbound conveyor 30. In the example shown in FIGS. 3 to 7, the first detector 81 and the second detector 82 are sensors that detect any article 4 based on interruption of light (photoelectric sensors). The first detector 81 and the second detector 82 may be other types of sensors, such as image sensors. In one embodiment, a detector having the function of the first detector 81 and the function of the second detector 82 may be installed. Such an embodiment also falls under an embodiment in which the automated warehouse 100 includes the first detector 81 and the second detector 82.

As shown in FIG. 5, the first detector 81 is installed at the X-direction position corresponding to each of the two X-direction ends of the article 4 disposed in the first positional relationship relative to the mount 12 of the first transport vehicle 10 at the fixed position. Thus, during adjustment of the position of the article 4 on the inbound conveyor 30, as shown in FIG. 4, when the article 4 is stopped at the position at which each first detector 81 detects the corresponding one of the two X-direction ends of the article 4, the article 4 on the inbound conveyor 30 can be stopped at the position at which the article 4 is disposed in the first positional relationship relative to the mount 12 of the first transport vehicle 10 at the fixed position.

As shown in FIG. 7, the second detector 82 is installed at the X-direction position corresponding to each of the two X-direction ends of the article 4 disposed in the second positional relationship relative to the mount 12 of the first transport vehicle 10 at the fixed position. Thus, during adjustment of the position of the article 4 on the inbound conveyor 30, as shown in FIG. 6, when the article 4 is stopped at the position at which each second detector 82 detects the corresponding one of the two X-direction ends of the article 4, the article 4 on the inbound conveyor 30 can be stopped at the position at which the article 4 is disposed in the second positional relationship relative to the mount 12 of the first transport vehicle 10 at the fixed position.

In the automated warehouse 100, movement (relocation) may be performed to move an article 4 stored in a storage row 6 to another storage row 6. For example, the movement is performed to sort articles 4 in shipping order or move an article 4 likely to be shipped to a location near the Y-direction path 7. As shown in FIGS. 10(a)-(d) to 12(a)-(c) , the article 4 to be moved will be referred to as the target article 4T.

As shown in FIG. 14, when performing movement (Yes in step #01), the controller 2 determines whether the destination storage row 6 can be selected from the storage area (A1, A2) including the source storage row 6 (step #02). More specifically, when the source storage row 6 is included in the first storage area A1, the controller 2 determines whether the destination storage row 6 can be selected from the first storage area A1. When the source storage row 6 is included in the second storage area A2, the controller 2 determines whether the destination storage row 6 can be selected from the second storage area A2. When the destination storage row 6 can be selected from the storage area (A1, A2) including the source storage row 6 (Yes in step #02), the controller 2 selects the destination storage row 6 from the storage area (A1, A2) including the source storage row 6. The controller 2 causes the first transport vehicle 10 and the second transport vehicle 20 to sequentially perform retrieval of the article 4 from the source (step #03) and storage of the article 4 into the destination (step #04).

In this manner, the transport vehicle 1 (in the present embodiment, the first transport vehicle 10 and the second transport vehicle 20) moves an article 4 stored in a storage row 6 to another storage row 6 as described below. When the source storage row 6 is included in the first storage area A1, the transport vehicle 1 selects the destination storage row 6 from the first storage area A1. When the source storage row 6 is included in the second storage area A2, the transport vehicle 1 selects the destination storage row 6 from the second storage area A2. As described above, the storage row 6 is selected by the controller 2, which controls the first transport vehicle 10 and the second transport vehicle 20.

FIGS. 10(a)-(d) shows an example of the movement. In this example, the source storage row 6 is a first storage row 6A included in the first storage area A1, whereas the destination storage row 6 is a second storage row 6B included in the first storage area A1. The movement is shown in chronological order in FIGS. 10(a), 10(b), 10(c), and 10(d).

As shown in FIGS. 10(a) to 10(b), the first transport vehicle 10 enters the first storage row 6A and retrieves the target article 4T from the first storage row 6A (step #03). The first transport vehicle 10 travels toward the first side X1 in the X-direction until the target article 4T is positioned in the first positional relationship relative to the mount 12, before raising the mount 12. This places the target article 4T onto the mount 12 in the first positional relationship. The first transport vehicle 10 exits the first storage row 6A with the mount 12 raised and then moves to the position in the Y-direction corresponding to the second storage row 6B while mounted on the second transport vehicle 20. As shown in FIGS. 10(c) to 10(d), the first transport vehicle 10 then enters the second storage row 6B with the mount 12 raised and stores the target article 4T into the second storage row 6B (step #04). When the target article 4T is stored into the second storage row 6B included in the first storage area A1, the target article 4T, which is placed on the mount 12 in the first positional relationship, can be stored close to the article previously stored in the second storage row 6B without the mount 12 of the first transport vehicle 10 colliding with the stored article.

Although not shown, the movement can be similarly performed also when the source storage row 6 is included in the second storage area A2 and the destination storage row 6 is included in the second storage area A2. In this case, when retrieving the article 4 from the source storage row 6, the first transport vehicle 10 travels toward the second side X2 in the X-direction until the target article 4T is positioned in the second positional relationship relative to the mount 12, before raising the mount 12. When the target article 4T is stored into the destination storage row 6 included in the second storage area A2, the target article 4T, which is placed on the mount 12 in the second positional relationship, can be stored close to the article previously stored in the destination storage row 6 without the mount 12 of the first transport vehicle 10 colliding with the stored article.

As described above, in the movement, the destination storage row 6 is typically selected from the storage area (A1, A2) including the source storage row 6. However, the destination storage row 6 for the target article 4T may not be selected from the storage area (A1, A2) including the source storage row 6. For example, when the storage area (A1, A2) including the source storage row 6 has no space for storing the target article 4T in any one of the storage rows 6 except the source storage row 6, the destination storage row 6 for the target article 4T is unselectable from the storage area (A1, A2) including the source storage row 6.

As shown in FIG. 14, when the destination storage row 6 for the target article 4T is unselectable from the storage area (A1, A2) including the source storage row 6 as described above (No in step #02), the controller 2 selects the destination storage row 6 from the storage area (A1, A2) including no source storage row 6. More specifically, when the source storage row 6 is included in the first storage area A1 with the destination storage row 6 unselectable from the first storage area A1, the controller 2 selects the destination storage row 6 from the second storage area A2. When the source storage row 6 is included in the second storage area A2 with the destination storage row 6 unselectable from the second storage area A2, the controller 2 selects the destination storage row 6 from the first storage area A1. The controller 2 then causes the first transport vehicle 10, the second transport vehicle 20, and the feeder 3 to sequentially perform the retrieval of the article 4 from the source (step #05), the specific loading (step #06), and the storage of the article 4 into the destination (step #07).

In the specific loading (step #06) performed when the source storage row 6 is included in the first storage area A1, the target article 4T is placed onto the mount 12 in the second positional relationship. In the specific loading (step #06) performed when the source storage row 6 is included in the second storage area A2, the target article 4T is placed onto the mount 12 in the first positional relationship.

In this manner, when the source storage row 6 for the target article 4T is included in the first storage area A1 and the destination storage row 6 for the target article 4T is unselectable from the first storage area A1, the controller 2 causes the transport vehicle 1 and the feeder 3 (in the present embodiment, the first transport vehicle 10, the second transport vehicle 20, and the feeder 3) to perform the specific loading to place the target article 4T onto the mount 12 in the second positional relationship before storing the target article 4T into the storage row 6 included in the second storage area A2. When the source storage row 6 for the target article 4T is included in the second storage area A2 and the destination storage row 6 for the target article 4T is unselectable from the second storage area A2, the controller 2 causes the transport vehicle 1 and the feeder 3 (in the present embodiment, the first transport vehicle 10, the second transport vehicle 20, and the feeder 3) to perform the specific loading to place the target article 4T onto the mount 12 in the first positional relationship before storing the target article 4T into the storage row 6 included in the first storage area A1.

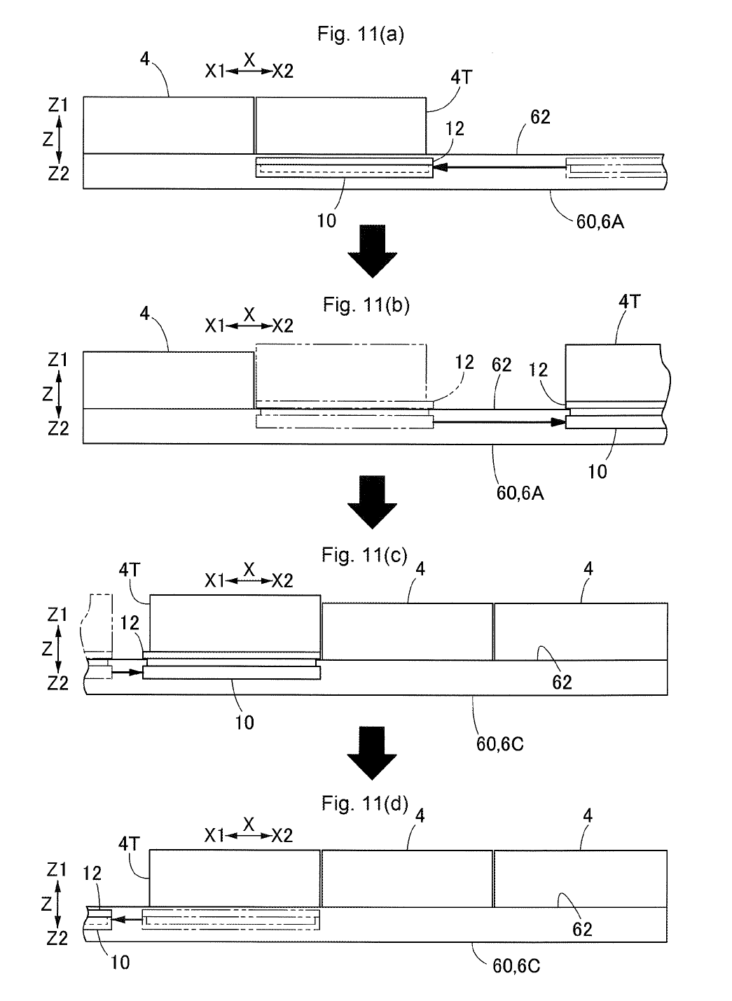

FIGS. 11(a)-(d) show an example of the movement. In this example, the source storage row 6 is the first storage row 6A included in the first storage area A1, whereas the destination storage row 6 is a third storage row 6C included in the second storage area A2. The movement is shown in chronological order in FIGS. 11(a), 11(b), 11(c),and 11(d), . FIGS. 12(a)-(c) show an example of the specific loading performed in the movement. In this example, the state in which the target article 4T is disposed in the first positional relationship relative to the mount 12 is changed to the state in which the target article 4T is disposed in the second positional relationship relative to the mount 12. The specific loading is shown in chronological order in FIGS. 12(a), 12(b), and 12(c). Although the specific loading (step #06) is performed on the inbound conveyor 30 in the example described below, the specific loading (step #06) may be performed on, for example, the outbound conveyor 40. In this case, for example, the same detectors as the first detector 81 and the second detector 82 are installed on the outbound conveyor 40.

As shown in FIGS. 11(a) to 11(b), the first transport vehicle 10 enters the first storage row 6A and retrieves the target article 4T from the first storage row 6A (step #05). The first transport vehicle 10 travels toward the first side X1 in the X-direction until the target article 4T is positioned in the first positional relationship relative to the mount 12, before raising the mount 12. This places the target article 4T onto the mount 12 in the first positional relationship. The first transport vehicle 10 exits the first storage row 6A with the mount 12 raised and then moves to the position in the Y-direction corresponding to the inbound conveyor 30 while mounted on the second transport vehicle 20. As shown in FIG. 12(a), the first transport vehicle 10 then enters the inbound conveyor 30 with the mount 12 raised and stops at the fixed position described above.

The first transport vehicle 10 lowers the mount 12 to place the target article 4T on the mount 12 onto the inbound conveyor 30. As shown in FIG. 12(b), the inbound conveyor 30 moves the target article 4T toward the second side X2 in the X-direction until the target article 4T is positioned in the second positional relationship relative to the mount 12 (refer to a white arrow in FIG. 12(b)), and then the first transport vehicle 10 raises the mount 12 as shown in FIG. 12(c). This places the target article 4T onto the mount 12 in the second positional relationship (step #06). The first transport vehicle 10 then exits the inbound conveyor 30 with the mount 12 raised.

The first transport vehicle 10 that has exited the inbound conveyor 30 moves to the position in the Y-direction corresponding to the third storage row 6C while mounted on the second transport vehicle 20. As shown in FIGS. 11(c) to 11(d), the first transport vehicle 10 then enters the third storage row 6C with the mount 12 raised and stores the target article 4T into the third storage row 6C (step #07). When the target article 4T is stored into the third storage row 6C included in the second storage area A2, the target article 4T, which is placed on the mount 12 in the second positional relationship, can be stored close to the article previously stored in the third storage row 6C without the mount 12 of the first transport vehicle 10 colliding with the stored article.

Although not shown, the movement can be similarly performed also when the source storage row 6 is included in the second storage area A2 and the destination storage row 6 is included in the first storage area A1. In this case, when retrieving the article 4 from the source storage row 6, the first transport vehicle 10 travels toward the second side X2 in the X-direction until the target article 4T is positioned in the second positional relationship relative to the mount 12, before raising the mount 12. This places the target article 4T onto the mount 12 in the second positional relationship. In the specific loading, the state in which the target article 4T is disposed in the second positional relationship relative to the mount 12 is changed to the state in which the target article 4T is disposed in the first positional relationship relative to the mount 12. When the target article 4T is stored into the destination storage row 6 included in the first storage area A1, the target article 4T, which is placed on the mount 12 in the first positional relationship, can be stored close to the article previously stored in the destination storage row 6 without the mount 12 of the first transport vehicle 10 colliding with the stored article.

### Other Embodiments

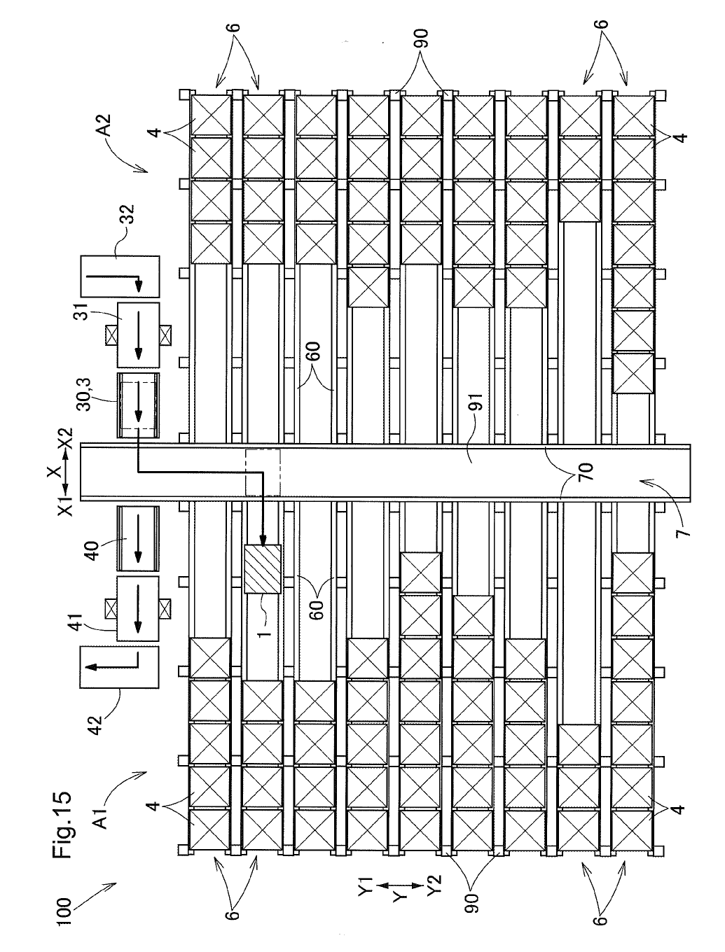

(1) In the above embodiment, the transport vehicle 1 includes the first transport vehicle 10 and the second transport vehicle 20. However, the present disclosure is not limited to this structure. For example, as shown in FIG. 15, the transport vehicle 1 may include a unit integrating the first transport vehicle 10 and the second transport vehicle 20, rather than including the first transport vehicle 10 and the second transport vehicle 20. In this case, the transport vehicle 1 has the functions of the first transport vehicle 10 and the functions of the second transport vehicle 20. The transport vehicle 1 travels along the Y-direction path 7 and also along each storage row 6 on the lower side Z2 under the articles 4 stored in the storage row 6 to transport an article 4. The operation of the transport vehicle 1 not including the first transport vehicle 10 or the second transport vehicle 20 is apparent from the operation of the first transport vehicle 10 and the second transport vehicle 20 in the above embodiment, and thus will not be described.

The transport vehicle 1 structured in this manner includes, for example, the mount 12 and the lift 13 as well as the first travel wheels 14 and the second travel wheels 22. The transport vehicle 1 travels along the Y-direction path 7 with the second travel wheels 22 in contact with the Y-direction rails 70 and along the storage rows 6 with the first travel wheels 14 in contact with the X-direction rails 60 (specifically, the running surfaces 61). In this case, for example, the transport vehicle 1 includes a mechanism for switching between the state in which the second travel wheels 22 are in contact with the Y-direction rails 70 and the state in which the first travel wheels 14 are in contact with the X-direction rails 60 (e.g., a mechanism for moving at least one of the first travel wheels 14 or the second travel wheels 22 in the vertical direction Z).

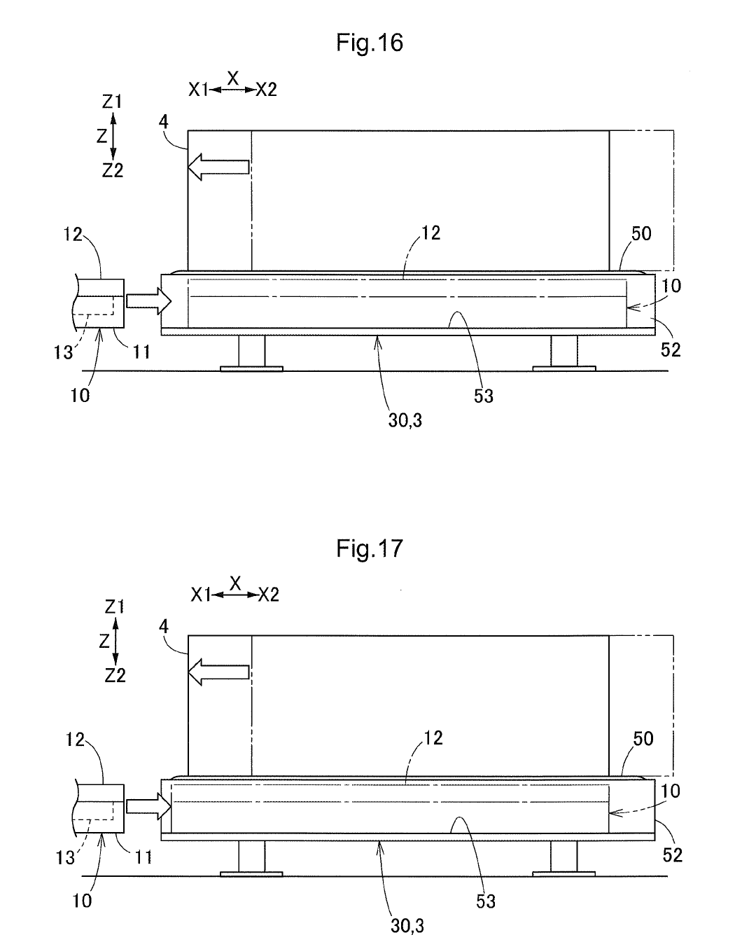

(2) In the above embodiment, both the feeder 3 and the first transport vehicle 10 perform the specific loading. However, the present disclosure is not limited to this structure. Either the feeder 3 or the first transport vehicle 10 may perform the specific loading. An example of the specific loading performed by the first transport vehicle 10 is shown in FIGS. 16 and 17. In the example shown in FIGS. 16 and 17, irrespective of whether the storage row 6 to store the article 4 is included in the first storage area A1 or the second storage area A2, the transfer of the article 4 from the inbound conveyor 30 to the first transport vehicle 10 is performed with the article 4 at a fixed position on the inbound conveyor 30 (the position of the article 4 indicated by a solid line in FIGS. 16 and 17). The adjustment of the positional relationship between the mount 12 and the article 4 during the specific loading is performed by adjusting the position of the first transport vehicle 10 that has entered the inbound conveyor 30.

More specifically, in the specific loading performed when the storage row 6 to store the article 4 is included in the first storage area A1, as shown in FIG. 16, the first transport vehicle 10 with the mount 12 lowered is stopped at a position at which the article 4 on the inbound conveyor 30 is disposed in the first positional relationship relative to the mount 12 (in this example, the positional relationship in which the X-direction end of the article 4 on the first side X1 in the X-direction coincides with the end of the mount 12 on the first side X1 in the X-direction). In this state, when the first transport vehicle 10 raises the mount 12, the article 4 is placed onto the mount 12 in the first positional relationship. The stopping position of the first transport vehicle 10 in this case is controlled based on, for example, detection results from the third detector 83 for the article 4 on the inbound conveyor 30 (e.g., detection results of the end position of the article 4 on the first side X1 in the X-direction). In the specific loading performed when the storage row 6 to store the article 4 is included in the second storage area A2, as shown in FIG. 17, the first transport vehicle 10 with the mount 12 lowered is stopped at a position at which the article 4 on the inbound conveyor 30 is disposed in the second positional relationship relative to the mount 12 (in this example, the positional relationship in which the X-direction end of the article 4 on the second side X2 in the X-direction coincides with the end of the mount 12 on the second side X2 in the X-direction). In this state, when the first transport vehicle 10 raises the mount 12, the article 4 is placed onto the mount 12 in the second positional relationship. The stopping position of the first transport vehicle 10 in this case is controlled based on, for example, detection results from the fourth detector 84 for the article 4 on the inbound conveyor 30 (e.g., detection results of the end position of the article 4 on the second side X2 in the X-direction).

(3) In the above embodiment, the article 4 to be stored in the storage row 6 is transferred from the inbound conveyor 30 to the first transport vehicle 10. However, the present disclosure is not limited to this structure. The article 4 to be stored in the storage row 6 may be transferred from the inbound conveyor 30 to the second transport vehicle 20 and then transferred from the second transport vehicle 20 to the first transport vehicle 10. In one example, the second transport vehicle 20 may include a conveyor on the supports 24 (refer to FIGS. 2 and 3) for conveying the article 4 in the X-direction. In this case, for example, when the second transport vehicle 20 positioned as shown in FIG. 3 activates the inbound conveyor 30 and the conveyor installed on the supports 24, the article 4 is transferred from the inbound conveyor 30 to the second transport vehicle 20. The first transport vehicle 10 mounted on the second transport vehicle 20 then raises the mount 12 to place the article 4 supported by the supports 24 onto the mount 12, transferring the article 4 from the second transport vehicle 20 to the first transport vehicle 10. In this case, the feeder 3 includes the conveyor installed on the supports 24 of the second transport vehicle 20, rather than the inbound conveyor 30.

In this embodiment, the specific loading may be performed when the article 4 is transferred from the second transport vehicle 20 to the first transport vehicle 10, instead of when the article 4 is transferred from the inbound conveyor 30 to the first transport vehicle 10 as described in the above embodiment. In this case, for example, the article 4 may be transferred from the second transport vehicle 20 to the first transport vehicle 10 with the first transport vehicle 10 at a fixed position on the second transport vehicle 20. The adjustment of the positional relationship between the mount 12 and the article 4 during the specific loading may be performed by adjusting the position of the article 4 on the conveyor installed on the supports 24 of the second transport vehicle 20. In this case, the specific loading is performed by the feeder 3 (in this example, the conveyor installed on the supports 24 of the second transport vehicle 20) and the first transport vehicle 10 in the same manner as in the above embodiment. In other examples, the article 4 may be transferred from the second transport vehicle 20 to the first transport vehicle 10 with the article 4 at a fixed position on the conveyor installed on the supports 24 of the second transport vehicle 20. The adjustment of the positional relationship between the mount 12 and the article 4 during the specific loading may be performed by adjusting the position of the first transport vehicle 10 on the second transport vehicle 20. In this case, the specific loading is performed by the first transport vehicle 10.

(4) In the above embodiment, the feeder 3 includes the conveyor (in the above embodiment, the inbound conveyor 30). However, the present disclosure is not limited to this structure. The feeder 3 may include a non-conveyor device for feeding articles 4 to the first transport vehicle 10, such as a fork transfer device.

(5) In the above embodiment, the mount 12 in the first transport vehicle 10 includes no conveyor for conveying articles 4 in the X-direction. However, the present disclosure is not limited to this structure. The mount 12 may include a conveyor that conveys articles 4 in the X-direction. In this case, with an article 4 placed on the mount 12, the conveyor can adjust the positional relationship between the article 4 and the mount 12 in the X-direction. The specific loading is thus not performed when the feeder 3 feeds the article 4 to the first transport vehicle 10 (e.g., when the article 4 is transferred from the inbound conveyor 30 to the first transport vehicle 10). The first transport vehicle 10 may perform the specific loading at any time while the article 4 is placed on the mount 12. For the transport vehicle 1 not including the first transport vehicle 10 or the second transport vehicle 20 as described above, the mount 12 included in the transport vehicle 1 may also include a conveyor that conveys articles 4 in the X-direction.

(6) The structure described in each of the above embodiments may be combined with the structures described in other embodiments (including combinations of the other embodiments described as other embodiments) unless any contradiction arises. The embodiments described herein are mere examples in all respects. The embodiments may be modified variously without departing from the spirit and scope of the present disclosure.

### Overview of Present Embodiment

An overview of the automated warehouse according to the embodiments described above is provided below.

An automated warehouse according to one aspect includes a Y-direction path extending in a Y-direction, a first storage area disposed on a first side in an X-direction relative to the Y-direction path, the X-direction intersecting with the Y-direction as viewed in a vertical direction, and including a plurality of storage rows arranged in the Y-direction for storing articles arranged in the X-direction, a second storage area disposed on a second side in the X-direction relative to the Y-direction path and including a plurality of storage rows arranged in the Y-direction for storing articles arranged in the X-direction, a first transport vehicle that travels along each of the plurality of storage rows on a lower side under the articles stored in the plurality of storage rows to transport the articles, a second transport vehicle that carries the first transport vehicle and travels along the Y-direction path, and a feeder that feeds an article to the first transport vehicle. The first transport vehicle includes a mount on which the article is placeable, and a lift that raises and lowers the mount. For the first transport vehicle to transport an article to be stored in a storage row among the plurality of storage rows, at least one of the feeder or the first transport vehicle performs specific loading for placing the article onto the mount of the first transport vehicle in a specific positional relationship. For a case in which the storage row to store the article is included in the first storage area, the specific positional relationship is a first positional relationship in which an end of the article on the first side in the X-direction is at a position in the X-direction which position coincides with a first end of the mount which first end is on the first side in the X-direction or which position is farther on the first side in the X-direction than the first end of the mount. For a case in which the storage row to store the article is included in the second storage area, the specific positional relationship is a second positional relationship in which an end of the article on the second side in the X-direction is at a position in the X-direction which position coincides with a second end of the mount which second end is on the second side in the X-direction or which position is farther on the second side in the X-direction than the second end of the mount.

When the storage row to store the article is included in the first storage area disposed on the first side in the X-direction relative to the Y-direction path, this structure can perform the specific loading to place the article on the mount of the first transport vehicle in the first positional relationship, or more specifically, prevent the mount of the first transport vehicle from protruding from the article toward the first side in the X-direction. When the storage row to store the article is included in the second storage area disposed on the second side in the X-direction relative to the Y-direction path, this structure can perform the specific loading to place the article on the mount of the first transport vehicle in the second positional relationship, or more specifically, prevent the mount of the first transport vehicle from protruding from the article toward the second side in the X-direction. This allows a storage target article to be stored close to the article previously stored in the storage row without the mount of the first transport vehicle colliding with the stored article, irrespective of whether the storage row to store the article is included in the first storage area or the second storage area.

In this manner, this structure can change the state achieved by the specific loading based on whether the storage row to store the article is included in the first storage area or the second storage area, allowing the storage target article to be stored close to the stored article irrespective of the storage area in which the storage row to store the article is included. When storage areas are provided on both sides in X-direction of the Y-direction path, this easily improves article storage efficiency in both the storage areas in the X-direction.

The feeder may include an inbound conveyor disposed along the Y-direction path in an area in the Y-direction to which at least one of the first storage area or the second storage area is unconnected. The inbound conveyor receives an article for storage into a storage row among the plurality of storage rows. The specific loading may be performed by adjusting a positional relationship between the mount and the article when the article is transferred from the inbound conveyor to the first transport vehicle.

This structure allows position adjustment between the article and the mount of the first transport vehicle for the specific loading through the operation of at least one of the inbound conveyor or the first transport vehicle for transferring the article from the inbound conveyor to the first transport vehicle. This eliminates the position adjustment performed separately for the specific loading, easily improving article transport efficiency. The first transport vehicle or the second transport vehicle is less likely to include a separate mechanism for the specific loading, thus easily having a simpler structure.

In the above structure in which the specific loading is performed by adjusting the positional relationship between the mount and the article when the article is transferred from the inbound conveyor to the first transport vehicle, the article may be transferred from the inbound conveyor to the first transport vehicle with the first transport vehicle at a fixed position. The positional relationship between the mount and the article during the specific loading may be adjusted by adjusting a position of the article on the inbound conveyor. The automated warehouse may include a first detector that detects the article being positioned on the inbound conveyor in the first positional relationship relative to the mount of the first transport vehicle at the fixed position, and a second detector that detects the article being positioned on the inbound conveyor in the second positional relationship relative to the mount of the first transport vehicle at the fixed position.

In this structure, when the article is transferred from the inbound conveyor to the first transport vehicle, the first detector or the second detector can detect the article on the inbound conveyor being at the position to be achieved by the specific loading. This allows the position adjustment for the specific loading to be performed properly through the operation of the inbound conveyor for transferring the article from the inbound conveyor to the first transport vehicle. In this position adjustment, the first transport vehicle can be kept at the fixed position, thus facilitating the simplification of the first transport vehicle control for the transfer of the article from the inbound conveyor to the first transport vehicle.

In the automated warehouse with any of the above structures, for movement of moving an article previously stored in a storage row among the plurality of storage rows to another storage row, the first transport vehicle and the second transport vehicle may select a destination storage row among the plurality of storage rows from the first storage area in response to a source storage row among the plurality of storage rows being included in the first storage area, and select a destination storage row among the plurality of storage rows from the second storage area in response to a source storage row among the plurality of storage rows being included in the second storage area.

In the movement, the article is retrieved from the source storage row as described below to avoid a collision between the stored article and the mount of the first transport vehicle. When the source storage row is included in the first storage area, the article to be retrieved may be placed onto the mount of the first transport vehicle in the first positional relationship. When the source storage row is included in the second storage area, the article to be retrieved may be placed onto the mount of the first transport vehicle in the second positional relationship. In the movement, the article is stored into the destination storage row as described below to store the storage target article close to the stored article while avoiding a collision between the stored article and the mount of the first transport vehicle. When the destination storage row is included in the first storage area, the storage target article may be placed onto the mount of the first transport vehicle in the first positional relationship. When the destination storage row is included in the second storage area, the storage target article may be placed onto the mount of the first transport vehicle in the second positional relationship.

In the movement, this structure selects the destination storage row from the first storage area when the source storage row is included in the first storage area. This structure selects the destination storage row from the second storage area when the source storage row is included in the second storage area. This allows matching between the above positional relationships described for retrieval of the article from the source storage row and storage of the article into the destination storage row, irrespective of whether the source storage row is included in the first storage area or in the second storage area. This allows avoidance of a collision with the stored article during article retrieval from the source storage row, avoidance of a collision with the stored article during article storage into the destination storage row, and storage of the article at a position close to the stored article in the destination storage row, without readjusting the positional relationship between the article to be moved and the mount of the first transport vehicle during the movement.

In the structure in which the first transport vehicle and the second transport vehicle perform the movement, the automated warehouse may further include a controller that controls the first transport vehicle, the second transport vehicle, and the feeder. In response to the source storage row for a target article as a target of the movement being included in the first storage area with the destination storage row for the target article being unselectable from the first storage area, the controller may cause the first transport vehicle, the second transport vehicle, and the feeder to perform the specific loading to place the target article onto the mount in the second positional relationship before storing the target article into a storage row among the plurality of storage rows included in the second storage area. In response to the source storage row for the target article being included in the second storage area with the destination storage row for the target article being unselectable from the second storage area, the controller may cause the first transport vehicle, the second transport vehicle, and the feeder to perform the specific loading to place the target article onto the mount in the first positional relationship before storing the target article into a storage row among the plurality of storage rows included in the first storage area.

In the movement, when the source storage row is included in the first storage area with the destination storage row unselectable from the first storage area, and when the source storage row is included in the second storage area with the destination storage row unselectable from the second storage area, this structure performs the specific loading and changes the destination storage row to a storage row included in another storage area to allow the target article and the mount of the first transport vehicle to be in the above positional relationship for both retrieval of the article from the source storage row and storage of the article into the destination storage row. For the cases described above, this allows avoidance of a collision with the stored article during article retrieval from the source storage row, avoidance of a collision with the stored article during article storage into the destination storage row, and storage of the article at a position close to the stored article in the destination storage row.

In the automated warehouse with any of the above structures, the mount may have a dimension in the X-direction larger than a dimension of at least one of the articles in the X-direction.

When the mount of the first transport vehicle has a dimension in the X-direction larger than the dimension of at least one of the articles in the X-direction as in this structure, the technique in one or more embodiments of the present disclosure can perform the above specific loading to prevent the mount of the first transport vehicle from protruding from the article into the stored article in the X-direction, irrespective of whether the storage row to store the article is included in the first storage area or the second storage area. The technique in one or more embodiments of the present disclosure thus easily improves article storage efficiency in both the storage areas in the X-direction when the mount of the first transport vehicle has a dimension in the X-direction larger than the dimension of at least one of the articles in the X-direction.

An automated warehouse according to another aspect includes a Y-direction path extending in a Y-direction, a first storage area disposed on the first side in an X-direction relative to the Y-direction path, the X-direction intersecting with the Y-direction as viewed in a vertical direction, and including a plurality of storage rows arranged in the Y-direction for storing articles arranged in the X-direction, a second storage area disposed on the second side in the X-direction relative to the Y-direction path and including a plurality of storage rows arranged in the Y-direction for storing articles arranged in the X-direction, a transport vehicle that travels along the Y-direction path and along each of the plurality of storage rows on a lower side under the articles stored in the plurality of storage rows to transport the articles, and a feeder that feeds an article to the transport vehicle. The transport vehicle includes a mount on which the article is placeable, and a lift that raises and lowers the mount. For the transport vehicle to transport an article to be stored in a storage row among the plurality of storage rows, at least one of the feeder or the transport vehicle performs specific loading for placing the article onto the mount of the transport vehicle in a specific positional relationship. For a case in which the storage row to store the article is included in the first storage area, the specific positional relationship is a first positional relationship in which an end of the article on the first side in the X-direction is at a position in the X-direction which position coincides with a first end of the mount which first end is on the first side in the X-direction or which position is farther on the first side in the X-direction than the first end of the mount. For a case in which the storage row to store the article is included in the second storage area, the specific positional relationship is a second positional relationship in which an end of the article on the second side in the X-direction is at a position in the X-direction which position coincides with a second end of the mount which second end is on the second side in the X-direction or which position is farther on the second side in the X-direction than the second end of the mount.

When the storage row to store the article is included in the first storage area disposed on the first side in the X-direction relative to the Y-direction path, this structure can perform the specific loading to place the article on the mount of the transport vehicle in the first positional relationship, or more specifically, prevent the mount of the transport vehicle from protruding from the article toward the first side in the X-direction. When the storage row to store the article is included in the second storage area disposed on the second side in the X-direction relative to the Y-direction path, this structure can perform the specific loading to place the article on the mount of the transport vehicle in the second positional relationship, or more specifically, prevent the mount of the transport vehicle from protruding from the article toward the second side in the X-direction. This allows a storage target article to be stored close to the article previously stored in the storage row without the mount of the transport vehicle colliding with the stored article, irrespective of whether the storage row to store the article is included in the first storage area or the second storage area.

In this manner, this structure can change the state achieved by the specific loading based on whether the storage row to store the article is included in the first storage area or the second storage area, allowing the storage target article to be stored close to the stored article irrespective of the storage area in which the storage row to store the article is included. When storage areas are provided on both sides in X-direction of the Y-direction path, this easily improves article storage efficiency in both the storage areas in the X-direction.

The feeder may include an inbound conveyor disposed along the Y-direction path in an area in the Y-direction to which at least one of the first storage area or the second storage area is unconnected. The inbound conveyor receives an article for storage into a storage row among the plurality of storage rows. The specific loading may be performed by adjusting a positional relationship between the mount and the article when the article is transferred from the inbound conveyor to the transport vehicle.

This structure allows position adjustment between the article and the mount of the transport vehicle for the specific loading through the operation of at least one of the inbound conveyor or the transport vehicle for transferring the article from the inbound conveyor to the transport vehicle. This eliminates the need to separately perform the position adjustment for the specific loading, easily improving article transport efficiency. This structure also reduces the need to install a separate mechanism for the specific loading on the transport vehicle, facilitating the simplification of the transport vehicle.

In the above structure in which the specific loading is performed by adjusting the positional relationship between the mount and the article when the article is transferred from the inbound conveyor to the transport vehicle, the article may be transferred from the inbound conveyor to the transport vehicle with the transport vehicle at a fixed position. The positional relationship between the mount and the article during the specific loading may be adjusted by adjusting a position of the article on the inbound conveyor. The automated warehouse may include a first detector that detects the article being positioned on the inbound conveyor in the first positional relationship relative to the mount of the transport vehicle at the fixed position, and a second detector that detects the article being positioned on the inbound conveyor in the second positional relationship relative to the mount of the transport vehicle at the fixed position.

In this structure, when the article is transferred from the inbound conveyor to the transport vehicle, the first detector or the second detector can detect the article on the inbound conveyor being at the position to be achieved by the specific loading. This allows the position adjustment for the specific loading to be performed properly through the operation of the inbound conveyor for transferring the article from the inbound conveyor to the transport vehicle. In this position adjustment, the transport vehicle can be kept at the fixed position, thus facilitating the simplification of the transport vehicle control for the transfer of the article from the inbound conveyor to the transport vehicle.

In the automated warehouse with any of the above structures, for movement of moving an article previously stored in a storage row among the plurality of storage rows to another storage row, the transport vehicle may select a destination storage row among the plurality of storage rows from the first storage area in response to a source storage row among the plurality of storage rows being included in the first storage area, and select a destination storage row among the plurality of storage rows from the second storage area in response to a source storage row among the plurality of storage rows being included in the second storage area.

In the movement, the article is retrieved from the source storage row as described below to avoid a collision between the stored article and the mount of the transport vehicle. When the source storage row is included in the first storage area, the article to be retrieved may be placed onto the mount of the transport vehicle in the first positional relationship. When the source storage row is included in the second storage area, the article to be retrieved may be placed onto the mount of the transport vehicle in the second positional relationship. In the movement, the article is stored into the destination storage row as described below to store the storage target article close to the stored article while avoiding a collision between the stored article and the mount of the transport vehicle. When the destination storage row is included in the first storage area, the storage target article may be placed onto the mount of the transport vehicle in the first positional relationship. When the destination storage row is included in the second storage area, the storage target article may be placed onto the mount of the transport vehicle in the second positional relationship.

In the movement, this structure selects the destination storage row from the first storage area when the source storage row is included in the first storage area. This structure selects the destination storage row from the second storage area when the source storage row is included in the second storage area. This allows matching between the above positional relationships described for retrieval of the article from the source storage row and storage of the article into the destination storage row irrespective of whether the source storage row is included in the first storage area or in the second storage area. This allows avoidance of a collision with the stored article during article retrieval from the source storage row, avoidance of a collision with the stored article during article storage into the destination storage row, and storage of the article at a position close to the stored article in the destination storage row, without readjusting the positional relationship between the article to be moved and the mount of the transport vehicle during the movement.

In the above structure in which the transport vehicle performs the movement, the automated warehouse may further include a controller that controls the transport vehicle and the feeder. In response to the source storage row for a target article as a target of the movement being included in the first storage area with the destination storage row for the target article being unselectable from the first storage area, the controller may cause the transport vehicle and the feeder to perform the specific loading to place the target article onto the mount in the second positional relationship before storing the target article into a storage row among the plurality of storage rows included in the second storage area. In response to the source storage row for the target article being included in the second storage area with the destination storage row for the target article being unselectable from the second storage area, the controller may cause the transport vehicle and the feeder to perform the specific loading to place the target article onto the mount of the first positional relationship before storing the target article into a storage row among the plurality of storage rows included in the first storage area.

In the movement, when the source storage row is included in the first storage area with the destination storage row unselectable from the first storage area, and when the source storage row is included in the second storage area with the destination storage row unselectable from the second storage area, this structure performs the specific loading and changes the destination storage row to a storage row included in another storage area to allow the target article and the mount of the transport vehicle to be in the above positional relationship for both retrieval of the article from the source storage row and storage of the article into the destination storage row. Even in the cases described above, this allows avoidance of a collision with the stored article during article retrieval from the source storage row, avoidance of a collision with the stored article during article storage into the destination storage row, and storage of the article at a position close to the stored article in the destination storage row.

In the automated warehouse with any of the above structures, the mount may have a dimension in the X-direction larger than a dimension of at least one of the articles in the X-direction.

When the mount of the transport vehicle has a dimension in the X-direction larger than the dimension of at least one of the articles in the X-direction as in this structure, the technique in one or more embodiments of the present disclosure can perform the above specific loading to prevent the mount of the transport vehicle from protruding from the article into the stored article in the X-direction, irrespective of whether the storage row to store the article is included in the first storage area or the second storage area. The technique in one or more embodiments of the present disclosure thus easily improves article storage efficiency in both the storage areas in the X-direction when the mount of the transport vehicle has a dimension in the X-direction larger than the dimension of at least one of the articles in the X-direction.

The automated warehouse according to one or more embodiments of the present disclosure produces at least one of the effects described above.

What is claimed is:

1. An automated warehouse, comprising:
a Y-direction path extending in a Y-direction;
a first storage area disposed on a first side in an X-direction relative to the Y-direction path, the X-direction intersecting with the Y-direction as viewed in a vertical direction, the first storage area comprising a plurality of storage rows arranged in the Y-direction for storing articles arranged in the X-direction;
a second storage area disposed on a second side in the X-direction relative to the Y-direction path, the second storage area comprising a plurality of storage rows arranged in the Y-direction for storing articles arranged in the X-direction;
a first transport vehicle configured to travel along each of the plurality of storage rows on a lower side under the articles stored in the plurality of storage rows to transport the articles;
a second transport vehicle configured to carry the first transport vehicle and travel along the Y-direction path; and
a feeder configured to feed an article to the first transport vehicle, and
wherein:
the first transport vehicle comprises:
a mount on which the article is placeable, and
a lift configured to raise and lower the mount,
for the first transport vehicle to transport an article to be stored in a storage row among the plurality of storage rows, at least one of the feeder or the first transport vehicle is configured to perform specific loading for placing the article onto the mount of the first transport vehicle in a specific positional relationship,
for a case in which the storage row to store the article is included in the first storage area, the specific positional relationship is a first positional relationship in which an end of the article on the first side in the X-direction is at a position in the X-direction which position coincides with a first end of the mount which first end is on the first side in the X-direction or which position is farther on the first side in the X-direction than the first end of the mount,
for a case in which the storage row to store the article is included in the second storage area, the specific positional relationship is a second positional relationship in which an end of the article on the second side in the X-direction is at a position in the X-direction which position coincides with a second end of the mount which second end is on the second side in the X-direction or which position is farther on the second side in the X-direction than the second end of the mount.

2. The automated warehouse according to claim 1, wherein:
the feeder comprises an inbound conveyor disposed along the Y-direction path in an area in the Y-direction to which at least one of the first storage area or the second storage area is unconnected, the inbound conveyor being configured to receive an article for storage into a storage row among the plurality of storage rows, and
the specific loading is performed by adjusting a positional relationship between the mount and the article when the article is transferred from the inbound conveyor to the first transport vehicle.

3. The automated warehouse according to claim 2, wherein:
the article is transferred from the inbound conveyor to the first transport vehicle with the first transport vehicle at a fixed position,
the positional relationship between the mount and the article during the specific loading is adjusted by adjusting a position of the article on the inbound conveyor, and
the automated warehouse comprises:
a first detector configured to detect the article being positioned on the inbound conveyor in the first positional relationship relative to the mount of the first transport vehicle at the fixed position, and
a second detector configured to detect the article being positioned on the inbound conveyor in the second positional relationship relative to the mount of the first transport vehicle at the fixed position.

4. The automated warehouse according to claim 1, wherein:
for movement of moving an article previously stored in a storage row among the plurality of storage rows to another storage row, the first transport vehicle and the second transport vehicle select a destination storage row among the plurality of storage rows from the first storage area in response to a source storage row among the plurality of storage rows being included in the first storage area, and select a destination storage row among the plurality of storage rows from the second storage area in response to a source storage row among the plurality of storage rows being included in the second storage area.

5. The automated warehouse according to claim 4, further comprising:
a controller configured to control the first transport vehicle, the second transport vehicle, and the feeder,
wherein in response to the source storage row for a target article as a target of the movement being included in the first storage area with the destination storage row for the target article being unselectable from the first storage area, the controller causes the first transport vehicle, the second transport vehicle, and the feeder to perform the specific loading to place the target article onto the mount in the second positional relationship before storing the target article into a storage row among the plurality of storage rows included in the second storage area, and
wherein in response to the source storage row for the target article being included in the second storage area with the destination storage row for the target article being unselectable from the second storage area, the controller causes the first transport vehicle, the second transport vehicle, and the feeder to perform the specific loading to place the target article onto the mount in the first positional relationship before storing the target article into a storage row among the plurality of storage rows included in the first storage area.

6. The automated warehouse according to claim 1, wherein:
the mount has a dimension in the X-direction larger than a dimension of at least one of the articles in the X-direction.

7. An automated warehouse, comprising:
a Y-direction path extending in a Y-direction;
a first storage area disposed on a first side in an X-direction relative to the Y-direction path, the X-direction intersecting with the Y-direction as viewed in a vertical direction, the first storage area comprising a plurality of storage rows arranged in the Y-direction for storing articles arranged in the X-direction;
a second storage area disposed on a second side in the X-direction relative to the Y-direction path, the second storage area comprising a plurality of storage rows arranged in the Y-direction for storing articles arranged in the X-direction;
a transport vehicle configured to travel along the Y-direction path and along each of the plurality of storage rows on a lower side under the articles stored in the plurality of storage rows to transport the articles; and
a feeder configured to feed an article to the transport vehicle, and
wherein:
the transport vehicle comprises:
a mount on which the article is placeable, and
a lift configured to raise and lower the mount,
for the transport vehicle to transport an article to be stored in a storage row among the plurality of storage rows, at least one of the feeder or the transport vehicle is configured to perform specific loading for placing the article onto the mount of the transport vehicle in a specific positional relationship,
for a case in which the storage row to store the article is included in the first storage area, the specific positional relationship is a first positional relationship in which an end of the article on the first side in the X-direction is at a position in the X-direction which position coincides with a first end of the mount which first end is on the first side in the X-direction or which position is farther on the first side in the X-direction than the first end of the mount,
for a case in which the storage row to store the article is included in the second storage area, the specific positional relationship is a second positional relationship in which an end of the article on the second side in the X-direction is at a position in the X-direction which position coincides with a second end of the mount which second end is on the second side in the X-direction or which position is farther on the second side in the X-direction than the second end of the mount.

8. The automated warehouse according to claim 7, wherein:
the feeder comprises an inbound conveyor disposed along the Y-direction path in an area in the Y-direction to which at least one of the first storage area or the second storage area is unconnected, the inbound conveyor being configured to receive an article for storage into a storage row among the plurality of storage rows, and
the specific loading is performed by adjusting a positional relationship between the mount and the article when the article is transferred from the inbound conveyor to the transport vehicle.

9. The automated warehouse according to claim 8, wherein:
the article is transferred from the inbound conveyor to the transport vehicle with the transport vehicle at a fixed position,
the positional relationship between the mount and the article during the specific loading is adjusted by adjusting a position of the article on the inbound conveyor, and
the automated warehouse comprises:
a first detector configured to detect the article being positioned on the inbound conveyor in the first positional relationship relative to the mount of the transport vehicle at the fixed position, and
a second detector configured to detect the article being positioned on the inbound conveyor in the second positional relationship relative to the mount of the transport vehicle at the fixed position.

10. The automated warehouse according to claim 7, wherein:
for movement of moving an article previously stored in a storage row among the plurality of storage rows to another storage row, the transport vehicle selects a destination storage row among the plurality of storage rows from the first storage area in response to a source storage row among the plurality of storage rows being included in the first storage area, and selects a destination storage row among the plurality of storage rows from the second storage area in response to a source storage row among the plurality of storage rows being included in the second storage area.

11. The automated warehouse according to claim 10, further comprising:
a controller configured to control the transport vehicle and the feeder,
wherein in response to the source storage row for a target article as a target of the movement being included in the first storage area with the destination storage row for the target article being unselectable from the first storage area, the controller causes the transport vehicle and the feeder to perform the specific loading to place the target article onto the mount in the second positional relationship before storing the target article into a storage row among the plurality of storage rows included in the second storage area, and
wherein in response to the source storage row for the target article being included in the second storage area with the destination storage row for the target article being unselectable from the second storage area, the controller causes the transport vehicle and the feeder to perform the specific loading to place the target article onto the mount in the first positional relationship before storing the target article into a storage row among the plurality of storage rows included in the first storage area.

12. The automated warehouse according to claim 7, wherein:
the mount has a dimension in the X-direction larger than a dimension of at least one of the articles in the X-direction.
